(19) United States
(12) Patent Application Publication
(10) Pub. No.: US 2024/0297485 A1
(43) Pub. Date: Sep. 5, 2024

(54) TRANSMISSION LINE BLOWER WITH A DRIVE SYSTEM

(71) Applicant: Condux International, Inc., Mankato, MN (US)

(72) Inventors: Michael Robert Johnson, Edina, MN (US); Bradley Paul Radichel, Edina, MN (US); David Jon Hassing, Mankato, MN (US); Heinz Ulrich Wortmann, Lino Lakes, MN (US)

(73) Assignee: Condux International, Inc., Mankato, MN (US)

(21) Appl. No.: 18/264,406

(22) PCT Filed: Feb. 4, 2022
(86) PCT No.: PCT/US2022/015350

§ 371 Date: Aug. 4, 2023

Related U.S. Application Data
(60) Provisional application No. 63/146,459, filed on Feb. 5, 2021.

(51) Int. Cl. H02G 1/08

(52) U.S. Cl. CPC H02G 1/086

(57) ABSTRACT

An integrated seal used in an air block of a transmission line conveying apparatus comprising: a ring-shaped front sealing member; a hollow cylindrical rear sealing member, the hollow cylindrical rear sealing member and the ring-shaped front sealing member sharing a central axis; and a connecting sealing member connecting the ring-shaped front sealing member and the hollow cylindrical rear sealing member.

### CROSS-REFERENCE TO RELATED APPLICATION(S)

This application is being filed on Feb. 4, 2022, as a PCT International application and claims the benefit of and priority to U.S. Application No. 63/146,459, filed on Feb. 5, 2021, titled TRANSMISSION LINE BLOWER WITH A DRIVE SYSTEM, the disclosure of which is hereby incorporated by reference in its entirety.

### BACKGROUND

Transmission lines are used for transmitting power or data signals. One type of transmission line is a fiber optic cable that can be used to transmit digital data using light signals. The use of fiber optic cable for data transmission is popular, at least in part due to the high data transmission rate and very fast transmission speed.

Transmission lines can be used to carry power or data signals short distances, such as within a building, or long distances, such as between neighboring cities. For longer distance communication, transmission lines are often installed in underground ducts (also referred to as conduits), where continuous transmission lines as long as 0.5, 1, 2, 5 kilometers, or more, are desired between manhole or hand hole locations.

Installation equipment such as transmission line blowers and transmission line pullers have been developed that can be used to insert transmission lines into ducts over long distances. It is desired to have a transmission line installation equipment which can facilitate smooth and stable advancement of the transmission line that is being installed.

### SUMMARY

In general terms, this disclosure is directed to a transmission line conveying apparatus. In one possible configuration and by non-limiting example, the transmission line conveying apparatus includes an air block that has an integrated seal. The integrated seal can help create an airtight air block. In another possible configuration and by non-limiting example, the transmission line conveying apparatus includes a load cell that can be used to monitor the drive force generated by a transmission line drive assembly and applied to the transmission line. A drive system, including both the integrated seal and the load cell, can facilitate the smoothness and stability of the advancement of the transmission line that is being installed.

One aspect is an integrated seal used in an air block of a transmission line conveying apparatus comprising: a ring-shaped front sealing member; a hollow cylindrical rear sealing member, the hollow cylindrical rear sealing member and the ring-shaped front sealing member sharing a central axis; and a connecting sealing member connecting the ring-shaped front sealing member and the hollow cylindrical rear sealing member.

Another aspect is an air block of a transmission line conveying apparatus comprising: an air block housing; and an integrated seal located in the air block housing, the integrated seal comprising: a ring-shaped front sealing member; a hollow cylindrical rear sealing member, the hollow cylindrical rear sealing member and the ring-shaped front sealing member sharing a central axis; and a connecting sealing member connecting the ring-shaped front sealing member and the hollow cylindrical rear sealing member.

A further aspect is a transmission line conveying apparatus comprising: a transmission line drive assembly configured to apply a first component of a motive force to a transmission line by an engagement between the transmission line drive assembly and the transmission line; and an air block configured to apply a second component of the motive force to the transmission line generated by pressurized air, comprising: an air block housing; and an integrated seal located in the air block housing, the integrated seal comprising: a ring-shaped front sealing member; a hollow cylindrical rear sealing member, the hollow cylindrical rear sealing member and the ring-shaped front sealing member sharing a central axis; and a connecting sealing member connecting the ring-shaped front sealing member and the hollow cylindrical rear sealing member.

Yet another aspect is a transmission line conveying apparatus comprising: a transmission line drive assembly configured to apply a first component of a motive force to a transmission line by an engagement between the transmission line drive assembly and the transmission line; an air block configured to apply a second component of the motive force to the transmission line generated by pressurized air; a mount frame, wherein the air block is fixed to the mount frame, and the transmission line drive assembly is slidably mounted to the mount frame; a load cell having a first connector secured to the air block and a second connector secured to the transmission line drive assembly, the load cell being configured to measure the first component of the motive force; and a local controller, the local controller being connected to an output port of the load cell to receive the measured first component of the motive force, the local controller being connected to the transmission line drive assembly to adjust operation parameters of the transmission line drive assembly to adjust the first component of the motive force, based on the measured first component of the motive force.

A further aspect is a method of operating a transmission line conveying apparatus including a transmission line drive assembly, an air block, a mount frame, a load cell secured between the transmission line drive assembly and the air block, and a local controller, comprising: measuring, by the load cell, a first component of a motive force applied to a transmission line by an engagement between the transmission line drive assembly and the transmission line; determining, by the local controller, the first component of the motive force is equal to or larger than a maximum motive force; and adjusting, by the local controller, operation parameters of the transmission line drive assembly to decrease the first component of the motive force.

### BRIEF DESCRIPTION OF THE DRAWINGS

FIG. 1 is schematic diagram illustrating an example transmission line conveying system being used to install a transmission line into a duct at a transmission line installation site.

FIG. 2 is a block diagram illustrating the example transmission line conveying system shown in FIG. 1.

FIG. 3 is a schematic block diagram illustrating an example of the local controller shown in FIG. 2.

FIG. 4 is a side perspective view illustrating another example line blower and an example mounting frame.

FIG. 5 is a cross-sectional view of the example liner blower and the example mounting frame shown in FIG. 4, taken at line A-A.

FIG. 6 is an exploded view of the example liner blower and the example mounting frame shown in FIG. 4.

FIG. 7 is a side perspective view illustrating the engagement between the transmission line assembly mount bearing glides and corresponding transmission line assembly mount bearing glide tracks.

FIG. 8 is a side perspective view of the blower lead in guide structure, the air block lead in guide structure, the first duct, the second duct, and the transmission line.

FIG. 9 is a side perspective view of the air block lead in guide structure of FIG. 8.

FIG. 10 is a side view of the air block lead in guide structure of FIG. 8.

FIG. 11 is a front view of the air block lead in guide structure of FIG. 8.

FIG. 12 is a side perspective view of the lower half of the air block lead in guide structure of FIG. 8.

FIG. 13 is a front perspective view of the lower half of the air block lead in guide structure of FIG. 8.

FIG. 14 is a side perspective view of the blower lead in guide structure of FIG. 8.

FIG. 15 is a front view of the blower lead in guide structure of FIG. 8.

FIG. 16 is a front perspective view of the blower lead in guide structure of FIG. 8.

FIG. 17 is a side perspective view illustrating the engagement between a portion of the air block lead in guide structure of FIG. 8 and two seals.

FIG. 18 is a side perspective view of the air block of FIG. 4. FIG. 19 is an exploded view of the air block of FIG. 4.

FIG. 20 a side perspective view of the air block lower housing of FIG. 18.

FIG. 21 is a side view of the air block lower housing of FIG. 18.

FIG. 22 is a front view of the air block lower housing of FIG. 18.

FIG. 23 a side perspective view of the air block upper housing of FIG. 18.

FIG. 24 is a bottom view of the air block upper housing of FIG. 18.

FIG. 25 a side perspective view of the integrated seal of FIG. 18.

FIG. 26 is a side view of the integrated seal of FIG. 18.

FIG. 27 is a top view of the integrated seal of FIG. 18.

FIG. 28 is a front perspective view of the integrated seal of FIG. 18.

FIG. 29 is a front perspective view of the lower half and the upper half of the integrated seal of FIG. 18.

FIG. 30 is a side perspective view of the integrated seal lower half of FIG. 19.

FIG. 31 is a side view of the integrated seal lower half of FIG. 19.

FIG. 32 is a top view of the integrated seal lower half of FIG. 19.

FIG. 33 is a front perspective view of the integrated seal lower half of FIG. 19.

FIG. 34 is a side perspective view of the engagement between the integrated seal and the air block housing.

FIG. 35 is a front perspective view of the engagement between the integrated seal lower half and the air block lower housing.

FIG. 36 is a front perspective view of the engagement between the integrated seal upper half and the air block upper housing.

FIG. 37 is a side view of the engagement between the integrated seal and the air block lead in guide structure.

FIG. 38 is a schematic diagram illustrating the functioning of the load cell of the transmission line conveying apparatus (also referred to as the line blower) of FIG. 2.

FIG. 39 is a diagram illustrating an example load cell.

FIG. 40 is a side perspective view of the load cell, the vertical plate, and the lower tractor drive.

FIG. 41 is a side view of the load cell, the vertical plate, and the lower tractor drive.

FIG. 42 is an exploded side perspective view of the load cell, the vertical plate, and the lower tractor drive.

FIG. 43 is a top perspective view of the engagement between the load cell and the lower tractor drive.

FIG. 44 is a flowchart illustrating a method of controlling the transmission line drive assembly of the line blower of FIG. 38.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

For a transmission line blower, a motive force generated by the transmission line blower and applied to the transmission line drives the transmission line through the duct. The motive force may generally include two components. The first component is a drive force generated by frictional engagement of the transmission line with a moving drive assembly. The second component is a pull force (i.e., suction) generated by air pressure difference in the duct. Pressurized air may be generated by an air compressor and introduced into the duct through an air block of the transmission line blower to create the air pressure difference in the duct.

There are many variables that impact whether or not such an installation will be successful. The drive force and the air pressure are both among those variables. As to the drive force, an excessive drive force may damage the transmission line by, for example, causing the transmission line to bend (also known as transmission line buckling), whereas an inadequate drive force may not provide the intended advancement speed of the transmission line. As to the air pressure, it is desired to have an airtight air block and most of the pressurized air is not lost by leaking out of the air block. If a gap is formed somewhere in the air block, the pressurized air inside of the air block can leak out, which can undesirably and significantly reduce the air pressure and rate of air flow into the duct.

The present disclosure relates to a transmission line conveying system, which can be used to install a transmission line. The transmission line conveying system includes a transmission line conveying apparatus (also referred to as a line blower) which has a drive system. The drive system has both an integrated seal in an air block and a load cell that can be used to monitor the drive force. The drive system can facilitate smooth and stable advancement of the transmission line that is being installed.

The term “transmission line” is used herein as a generic term for any type of wire, cable, or other elongate structure capable of transmitting energy, whether in the form of a fiber optic cable, power line, electrical cable, telephone line (copper line), coaxial cable, or the like. For simplicity, the present disclosure may refer to a particular example of a transmission line, namely a fiber optic cable. However, the transmission line conveying system can be used in the same manner for installation of any other transmission line, and therefore the present disclosure should not be interpreted to be limited to installation of fiber optic cables. Instead, the transmission line conveying system can also be used for installing power lines, telephone lines, coaxial cables, and any other desired transmission line. In typical embodiments the transmission line conveying system is configured to install a transmission line within a conduit such as a duct. Additionally, a transmission line conveying system can also be used for other purposes, such as for installing a pull tape or other pull line, an inner duct, or other items within a conduit.

Although the term “transmission line” is sometimes used (such as in radio-frequency engineering) to refer to a specific type of line used to carry radio frequency signals, the term “transmission line” is not intended to be so limited in the present disclosure, but rather is intended to broadly include the transmission of any type of energy or signal (electricity, radio frequency, light, etc.) along an elongate and flexible structure. Specifically, examples of transmission lines include those that can transmit electricity, such as a wire; or light, such as a fiber optic cable including optical fibers.

One particular type of transmission line is an ultra-high fiber count (UHFC) fiber optic cable. Such a cable often contains thousands of optical fibers, housed within a protective enclosure. The transmission line conveying system can be used to install ultra-high fiber count fiber optic cables. In other embodiments the transmission line conveying system can be used to install various other types of transmission lines.

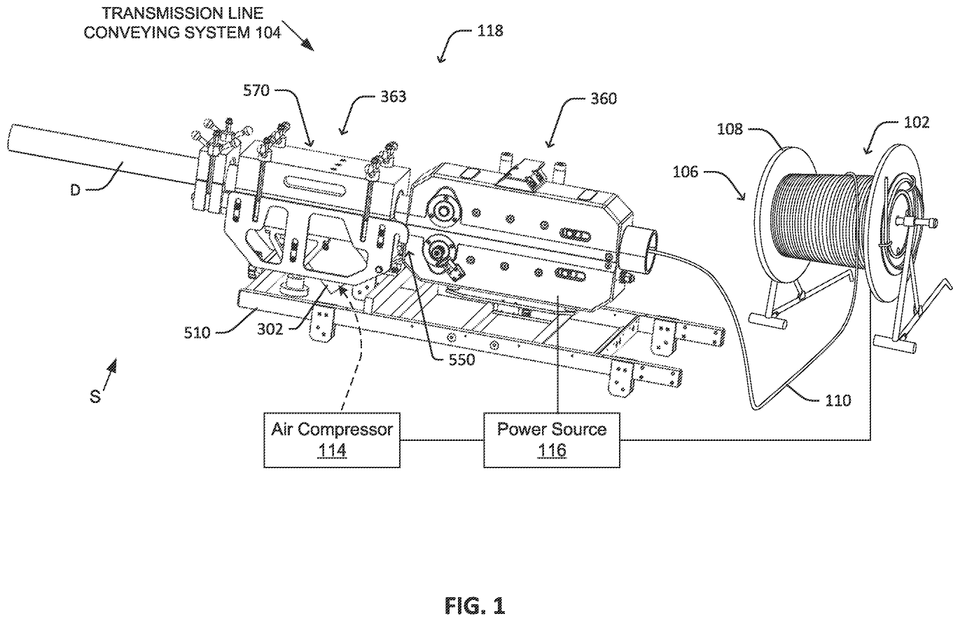

FIG. 1 is schematic diagram illustrating an example transmission line conveying system 104 being used to install a transmission line 110 into a duct D at a transmission line installation site S. In the illustrated example in FIG. 1, the transmission line conveying system 104 includes, among other things, a transmission line conveying apparatus (also referred to as a line blower) 118, a transmission line source 102, an air compressor 114, and a power source 116. It should be noted that the transmission line conveying system 104 may include other components such as an air heater, an air cooler, a humidifier, an air dryer, a static charge elimination device, a moisturizer, a lubricator, or combinations of these, such as a lubricator and moisturizer combination or other combinations. In some embodiments one or more of these components can also or alternatively operate as a duct primer, or in other embodiments a separate duct primer can be provided. These components can be separate components or can be part of the air compressor 114 or the line blowers 118. Also shown in FIG. 1 is the transmission line installation site S containing a duct D, for receiving the transmission line 110.

It should be noted that FIG. 1 is an example of the single line blower arrangement where a single line blower 118 is employed to install the transmission line 110 into the duct D. In other examples, multiple line blowers may be employed in a cascaded line blower arrangement to install the transmission line, often for long distance scenarios. In a non-limiting example, the transmission line can be installed into a proximal end of a first duct using a first line blower, and the transmission line coming out of a distal end of the first duct can be further installed into a proximal end of a second duct using a second line blower located between the first duct and the second duct, and the transmission line coming out of a distal end of the second duct can be further installed into a proximal end of a third line blower. In summary, the line blower 118 disclosed herein can be used in both the single line blower arrangement and the cascaded line blower arrangement.

Although the route of the duct D is illustrated in FIG. 1 as being straight and flat, often the route is not straight and flat, and instead the route of the duct D may have multiple bends, slopes, and other features, such as around a building or to follow under or along a road, etc. Additionally, the exact route of the ducts D is often not precisely known after the duct is installed, and therefore in some embodiments a route evaluation system can be used to evaluate and determine the geometry of the route of the duct D prior to cable installation.

Specifications of the duct include, for example, internal diameter of the duct, the composition of or frictional characteristics of the duct's interior coating or surface, whether the duct contains interior ribs, ridges, or other features or textures, the number of duct segments, the length of each duct segment, the quantity and location of hand holes, and the like. Specifications of the transmission line include, for example, type, outer diameter, specific weight, stiffness, minimum bend radius, break point, composition of or frictional characteristics of the transmission line's outer coating or surface, cross-sectional shape (circular, hexagonal, etc.).

The example transmission line source 102 includes a reel stand 106 for holding a transmission line reel 108 containing the transmission line 110. The transmission line source 102 is the source of the transmission line 110 that is to be installed at the site S. The line blower 118 operates to receive the transmission line 110 from the transmission line source 102 (reel stand 106 and transmission line reel 108) and to advance the transmission line 110 through the duct D, in cooperation with components such as the air compressor 114. The transmission line 110 is typically wound around the transmission line reel 108, and the reel stand 106 operates to elevate the transmission line reel 108 above the ground to allow the transmission line reel 108 to rotate and feed the transmission line 110 to the line blower 118.

The line blower 118 includes, among other things, a transmission line drive assembly 360, an air block 363, and a load cell 550 therebetween. The transmission line drive assembly 360 and the air block 363 are mounted on a mount frame 510. The transmission line drive assembly 360 frictionally engages the transmission line 110 so as to provide the first component of the motive force, namely the drive force generated by frictional engagement of the transmission line 110 with the transmission line drive assembly 360. The transmission line 110 advances through the transmission line drive assembly 360 and enters the air block 363.

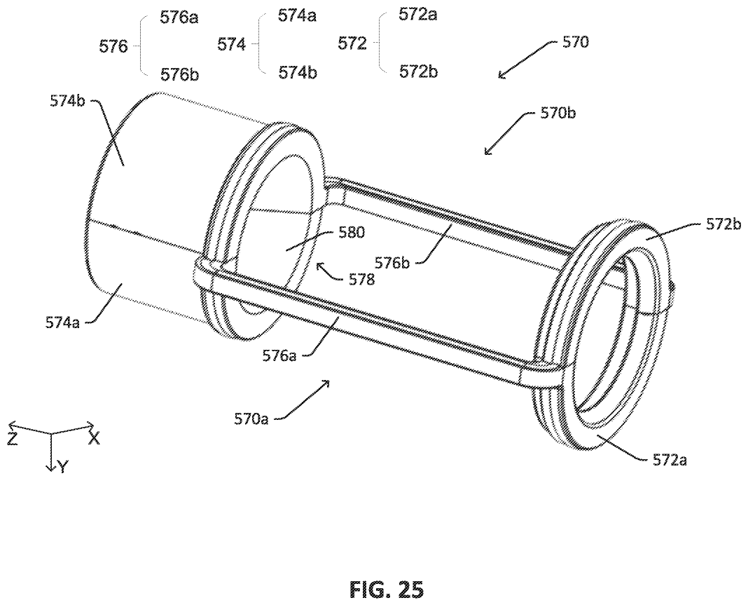

The air block 363 links both the transmission line 110 received from the transmission line drive assembly 360 and the air compressor 114 with duct D. In one example, the air block 363 includes an integrated seal 570, which helps make the air block 363 airtight. The integrated seal 570 will be described in detail with reference to FIGS. 25-33. The integrated seal 570, in addition with other components in the air block 363, help make the air block 363, and most of the pressurized air that is produced by the air compressor and enters the air block 363 through an air input port 302, is not lost by leaking out of the air block 363. As such, an air pressure difference is created in the duct, with the pressure at the proximal end of the duct D higher than the pressure at the distal end of the duct D. As a result, the second component of the motive force, namely the pull force (i.e., suction) generated by the air pressure difference in the duct D is applied to the transmission line 110. The motive force generated by the line blower 118 is the resultant force of the first component and the second component, and the motive force applied to the transmission line 110 drives the transmission line through the duct D.

The air compressor 114 provides a source of pressurized air to the line blower 118, and in some embodiments also includes a compressor module that operates to detect qualities of the air and conditions the air prior to delivery to the line blower 118. In some embodiments the compressor module further includes air throughput ports that act like a bypass through which the pressurized air from the air compressor 114 can pass through. The compressor module may also sensors to analyze qualities of the air as it moves through the throughput ports and before it is delivered to the line blower 118, and to transmit the detected data to one or more other components of the transmission line conveying system 104, or remotely, such as to an installation monitoring and management system. In some embodiments the sensors detect one or more of air pressure, temperature, and humidity. Further, in some embodiments the compressor module can operate to modify the quality of the air, such as to adjust one or more of the air pressure, temperature, humidity, moisture, and lubrication.

The power source 116 is a source of energy for the transmission line conveying system 104. The power source 116 provides energy to components of the transmission line conveying system 104, including but not limited to the line blower 118, the air compressor 114, and the reel stand 106. In the example of FIG. 1, the power source 116 is electrically connected to the line blower 118, the air compressor 114, and the reel stand 106. In some embodiments the energy is electrical energy. Examples of electrical power sources include batteries, connections to mains power, a generator, or the like. In other embodiments the energy can be in the form of hydraulic or pneumatic energy.

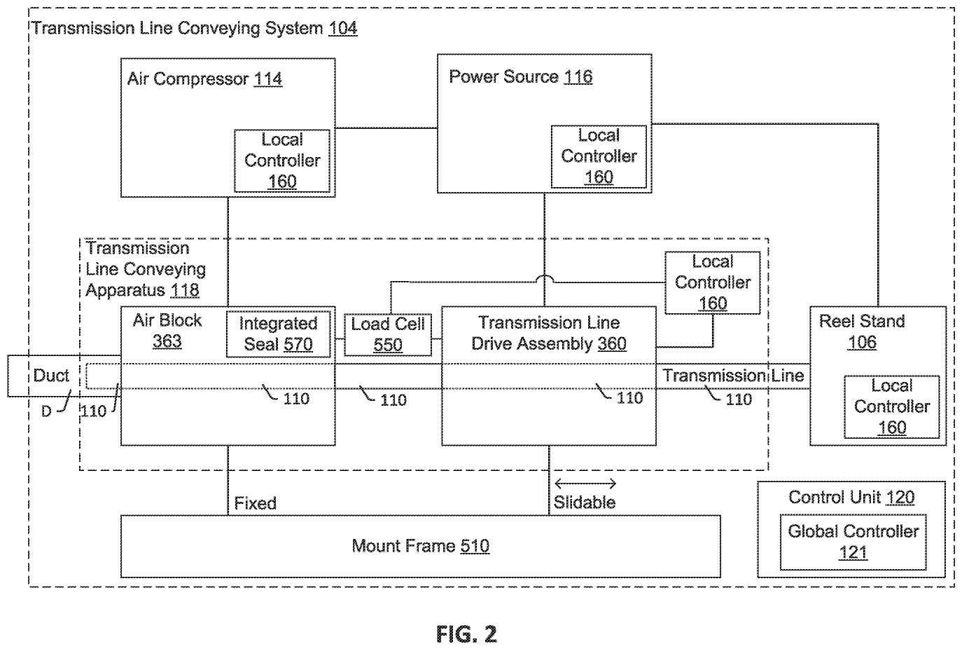

FIG. 2 is a block diagram illustrating the example transmission line conveying system 104 shown in FIG. 1. The transmission line conveying system 104 includes, among other things, the transmission line conveying apparatus (also referred to as the line blower) 118, the power source 116, the reel stand 106, the air compressor 114, the mount frame 510. The line blower 118 includes, among other things, the transmission line drive assembly 360, the air block 363, and the load cell 550. As described above, the transmission line 110 advances through the transmission line drive assembly 360 and the air block 363 and then enters the proximal end of the duct D. As described above, the air block 363 includes an integrated seal 570, which helps make the air block 363 airtight.

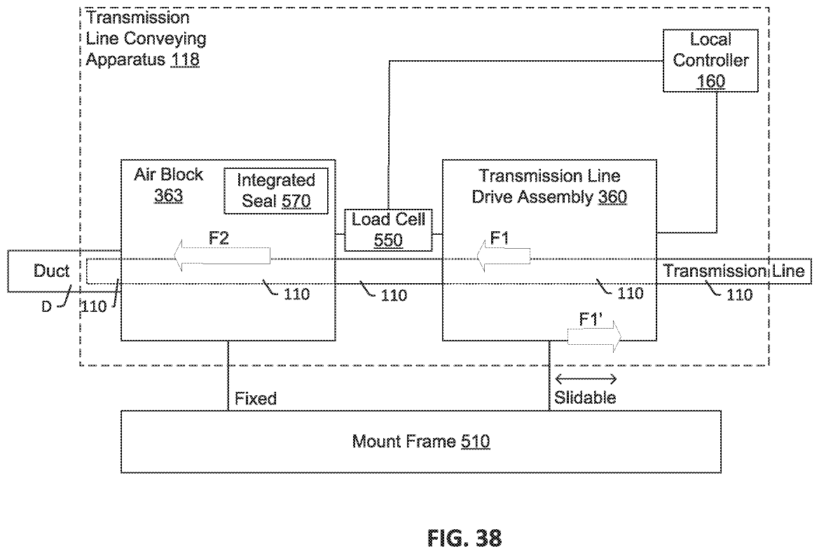

The air block 363 is fixed to the mount frame 510, whereas the transmission line drive assembly 360 is slidably mounted on the mount frame 510. In other words, the air block 363 cannot move relative to the mount frame 510, whereas the transmission line drive assembly 360 may move relative to the mount frame 510, either in the direction of the advancement of the transmission line 110 or in the direction of the retreat of the transmission line 110. Therefore, the transmission line drive assembly 360 may move relative to the air block, and a displacement of the transmission line drive assembly 360 exists. The load cell 550 is located between the transmission line drive assembly 360 and the air block 363. One end (e.g., one connector) of the load cell 550 is secured to the air block 363, and another end (e.g., another connector) of the load cell 550 is secured to the transmission line drive assembly 360. The displacement of the transmission line drive assembly 360 relative to the air block 363 results in either tension or compression of the load cell 550. Thus, the load cell 550 can measure the first component of the motive force, namely the drive force generated by frictional engagement of the transmission line 110 with the transmission line drive assembly 360, based on the tension or the compression of the load cell 550. The functioning of the load cell 550 will be described in detail below with reference to FIGS. 38-43.

The load cell 550 is connected to a local controller 160 of the line blower 118, which is also connected to the transmission line drive assembly 360. The local controller 160 can obtain the first component of the motive force by for example reading the output signals of the load cell 550. The local controller 160 of the line blower 118 can control the transmission line drive assembly 360 to adjust the operation parameters of the transmission line drive assembly 360 to adjust the first component of the motive force based on the measured first component of the motive force. For instance, when the measured first component of the motive force is equal to or larger than a maximum motive force, the local controller 160 of the liner blower 118 may adjust the operation parameters of the transmission line drive assembly 360 to decrease the first component of the motive force until it is below the maximum motive force. In another example, when the measured first component of the motive force is equal to or lower than a minimum motive force, the local controller 160 of the liner blower 118 may adjust the operation parameters of the transmission line drive assembly 360 to increase the first component of the motive force until it is above the minimum motive force. In another example, the local controller 160 of the liner blower 118 may adjust the operation parameters of the transmission line drive assembly 360, based on the measured first component, to maintain the first component of the motive force within an expected range. The expected range may be configured by an operator such as an installation technician. As such, the load cell 550, the local controller 160 of the line blower 118, and transmission line drive assembly 360 together may provide a negative feedback loop to regulate the first component of the motive force, therefore improving the smoothness and stability of the advancing transmission line 110 and avoiding potential buckling of the transmission line 110.

The transmission line conveying system 104 further includes a control unit 120. In one embodiment, the control unit 120 is a computing device that provides an interface between the installation technician and the transmission line conveying system 104. In some embodiments, the control unit 120 receives control inputs from the installation technician, such as to start and stop an installation. In some embodiments the control unit 120 provides status information to the installation technician, such as to convey the current status of the installation and to show the progress that has already been made.

On the other hand, the control unit 120 may operates as a global controller 121 in some embodiments. In the example of FIG. 2, the global controller 121 and the local controllers 160 of the line blower 118, the reel stand 106, the air compressor 114, and the power source 116 are configured to communicate with each other according to a predefined communication protocol to automatically identify each other and to make use of resources or information provided by the connected components (i.e., the line blower 118, the reel stand 106, the air compressor 114, and the power source 116 in the example of FIG. 2). For example, when a new component is added to the transmission line conveying system 104, a local controller of the new component 113 and the global controller 121 communicate with each other to identify each other and determine the resources (including features and functionality) or information that are now available to the transmission line conveying system 104 as a result. The transmission line conveying system 104 can therefore operate in such a way that it utilizes the resources available to it, and similarly can identify any problems or deficiencies in the current system configuration and make recommendations to the operator to change the configuration if needed. When an installation plan is developed, as discussed herein, the plan can be customized based on the specific configuration of the system at that time. Similarly, other parts such as the duct itself, the transmission line or transmission line reel, and the like can also be identified by the transmission line conveying system 104, such as by reading an RFID tag or communicating with a local controller associated with those parts, to identify characteristics of the parts.

In some embodiments the control unit 120 and the components (i.e., the line blower 118, the reel stand 106, the air compressor 114, and the power source 116 in the example of FIG. 2) are fully operable individually regardless of whether or not they are connected with the control unit 120 or other components. When connected they cooperate with each other to utilize the resources of the others, and when disconnected they operate with whatever resources are available.

In some embodiments the local controllers 160 may communicate with each other using peer-to-peer communication and are capable of independently controlling their respective components (i.e., the line blower 118, the reel stand 106, the air compressor 114, and the power source 116 in the example of FIG. 2). The local controllers 160 may operate to communicate with the local controllers 160 of other components so that they can synchronize their operations and utilize information from other components, whether commands or data, in determining how best to control their own components. The local controllers 160 are autonomous and are programmed to react to information received from the control unit 120 and other local controllers 160, without needing to be continually controlled by a global controller.

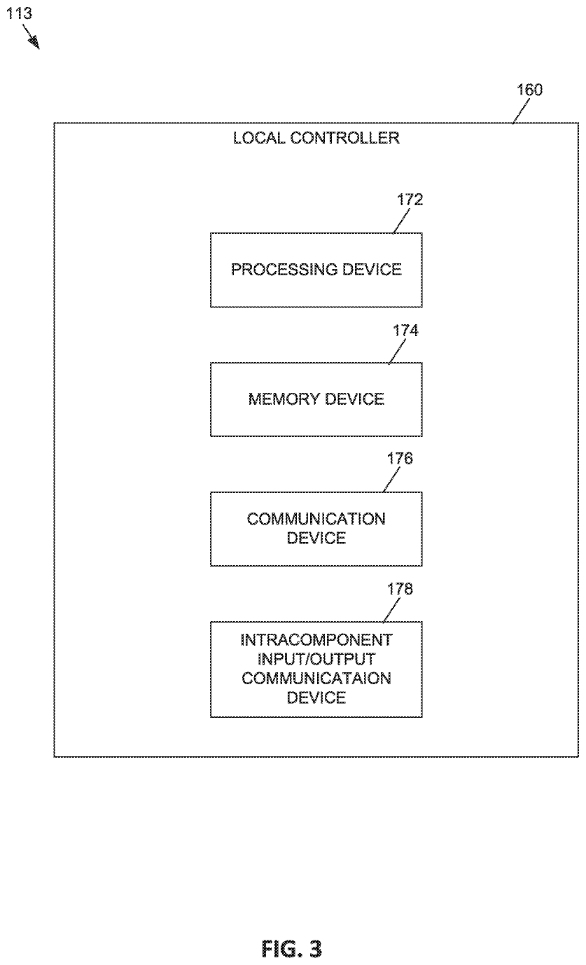

FIG. 3 is a schematic block diagram illustrating an example of the local controller 160 shown in FIG. 2. In this example, the local controller 160 includes, among other things, a processing device 172, a memory device 174, a communication device 176, and an intracomponent input/output communication device 178.

The local controller 160 controls the overall operation of the component, and communicates through the communication device 176 with other local controllers 160 and the control unit 120 in the transmission line conveying system 104. For example, in some embodiments the local controller 160 receives commands in the form of messages or instructions from the control unit 120 through the communication device 176. Examples of such commands include start, stop, and speed adjustments (a particular speed setting, an instruction to increase the speed, or an instruction to decrease the speed, etc.). Further, in some embodiments the local controller 160 also sends messages or instructions to other components through the communication device 176. For example, measured data or current or historical settings can be transmitted by the local controller 160 to other components.

The processing device 172 operates to process data instructions to perform functions of the component (e.g., the liner blower 118). The memory device 174 stores data instructions, which when executed by the processing device 172, cause the processing device to perform corresponding functions. The memory device 174 does not include transitory media carrying data signals. An example of the memory device 174 is a computer readable data storage device as described in further detail herein.

The communication device 176 is a device that communicates with other devices, including but not limited to the control unit 120 and other local controllers 160, via wired or wireless data communication. In some embodiments the communication device 176 communicates with all of the control unit 120 and other local controllers 160.

The communication device 176 can utilize wireless or wired communication devices. Examples of wireless communication devices include cellular communication devices, Wi-Fi (IEEE 802.11x) communication devices, and BLUETOOTH communication devices. Wired communication devices include modems, USB devices, serial and other I/O communication devices and techniques.

The intracomponent input/output communication device 178 operates to communicate with and control subsystems, sensors, or other electronic or controllable devices within the component (e.g., the line blower 118), utilizing wired or wireless communication or control signals. For example, the intracomponent input/output communication device 178 of the line blower 118 is coupled to the load cell 550 and the transmission line drive assembly 360 in some embodiments.

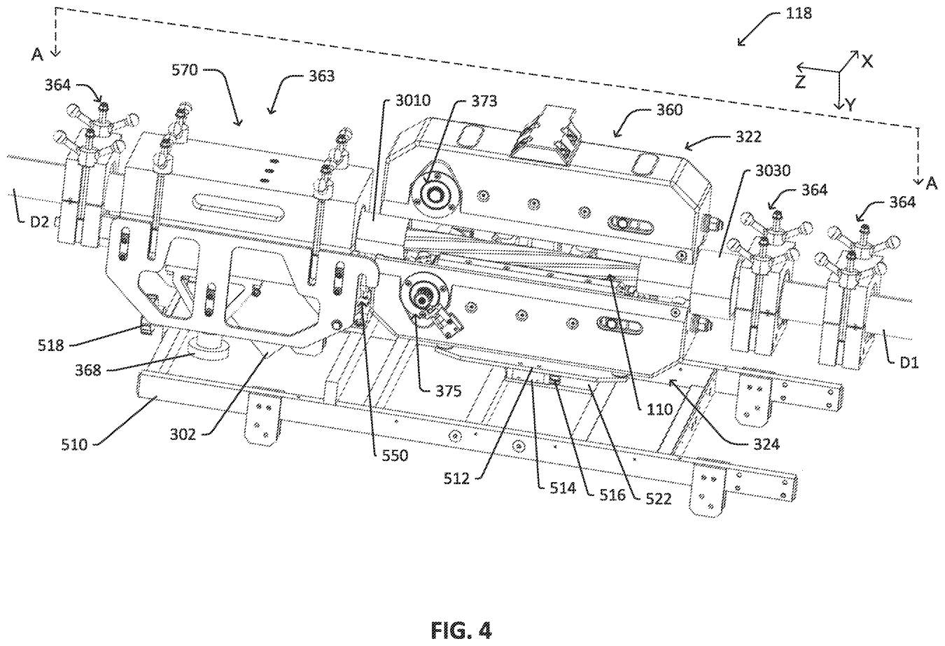

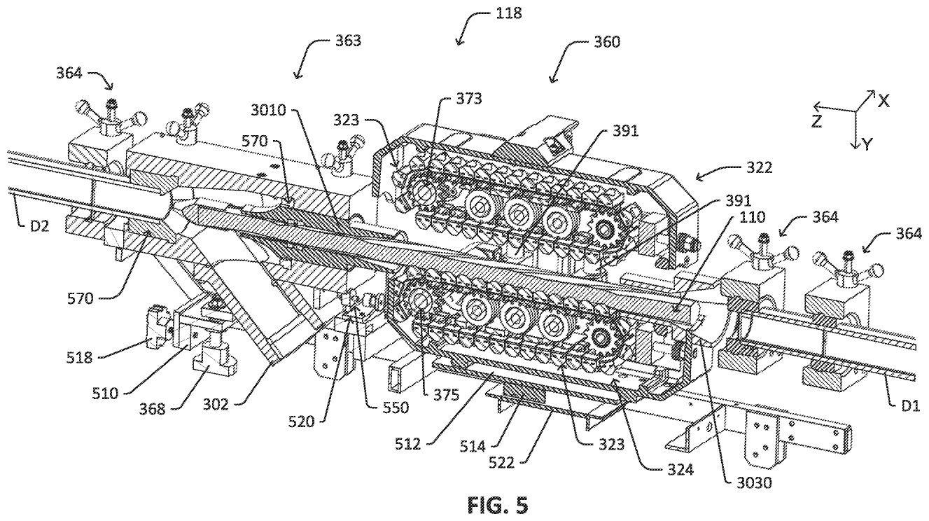

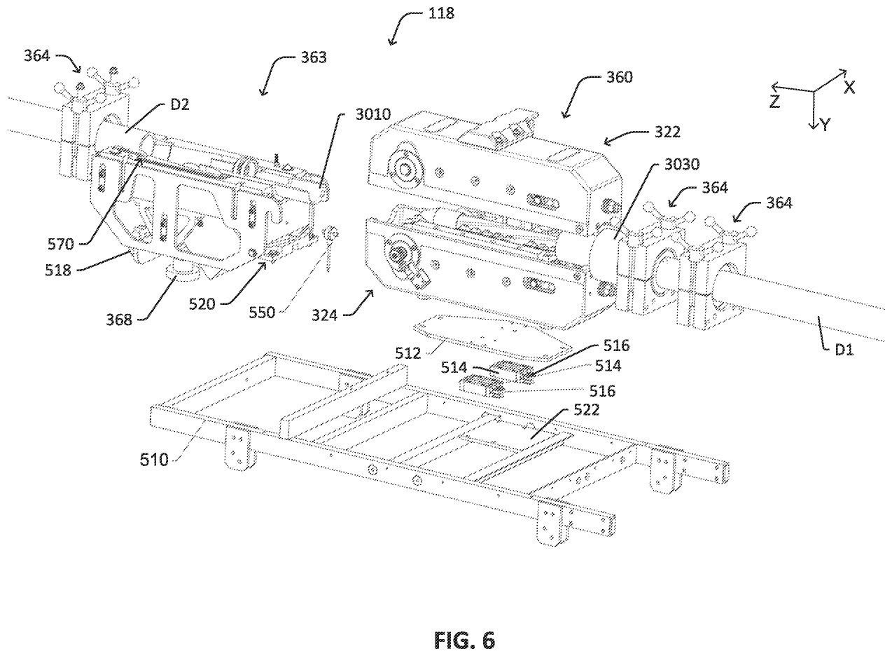

FIG. 4 is a side perspective view illustrating another example line blower 118 and an example mount frame 510. FIG. 5 is a cross-sectional view of the example liner blower 118 and the example mount frame 510 shown in FIG. 4, taken at line A-A. FIG. 6 is an exploded view of the example liner blower 118 and the example mount frame 510 shown in FIG. 4. The example line blower 118 shown in FIGS. 4-6 is connected between a first duct DI and a second duct D2. In other words, the line blower shown in FIG. 4 is in a cascade line blower arrangement as described above. It should be noted that the features of the example line blower 118 shown in FIGS. 4-6 may also be applicable to a line blower in a single line blower arrangement. It should also be noted that the transmission line 110 in FIGS. 4-6 are shown in various locations with various lengths for illustration, and the actual location at a certain time and the actual length of the transmission line 110 may vary.

The line blower 118 in this example is located between a first duct D1 and a second duct D2 extending in the Z direction. The transmission line 110 is advancing in the Z direction, coming out of the distal end of the first duct D1, passing through the line blower 118, and eventually entering the proximal end of the second duct D2. Duct clamps 364 are configured to secure the distal end of the first duct D1 to the input of the line blower 118 and the proximal end of the second duct D2 to the output of the line blower 118.

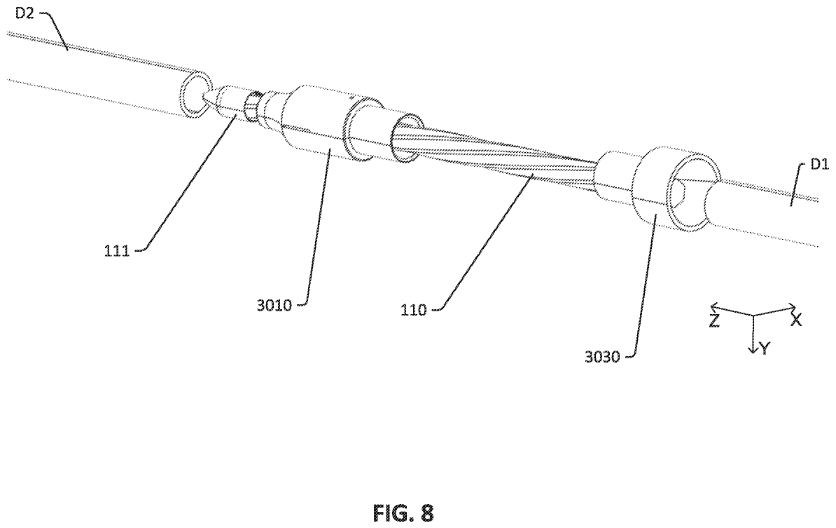

In the example shown in FIGS. 4-6, the transmission line 110 advances, approximately in the Z direction, through the first duct D1 and enters the transmission line drive assembly 360 through a blower lead in guide structure 3030. The first component of the motive force is generated by frictional engagement of the transmission line 110 with transmission line drive assembly 360. The transmission line 110 then enters the air block 363 through an air block lead in guide structure 3010. Eventually the transmission line 110 enters the second duct D2 and continues advancing, approximately in the Z direction. The blower lead in guide structure 3030 and the air block lead in guide structure 3010 facilitate the smooth advancing of the transmission line 110 and will be described in detail below with reference to FIGS. 8-17.

The line blower 118 includes, among other things, the transmission line drive assembly 360 and the air block 363. The transmission line drive assembly 360 further includes an upper tractor drive 322 and a lower tractor drive 324. The upper tractor drive 322 and the lower tractor drive 324 oppose each other and are aligned in the Y direction. It should be noted that the upper tractor drive 322 in FIGS. 4-6 has been lifted in the Y direction for better illustration of the interior components and the functioning of the transmission line drive assembly 360. In actual use, both the lower tractor drive 324 and the upper tractor drive 322 are in contact with the transmission line 110 to provide the frictional engagement with the transmission line 110.

As shown in FIG. 5, each of the upper tractor drive 322 and the lower tractor drive 324 includes an endless chain 323. The endless chains 323 engage with the upper surface and the lower surface of the transmission line 110, respectively, to provide the first component of the motive force. It should be noted that other moveable drive members besides opposed endless chains 323 are within the scope of the disclosure, including wheels and/or belts. The endless chains 323 are driven by an upper drive motor 373 and a lower drive motor 375, respectively. In the example shown in FIGS. 4-6, the upper drive motor 373 and the lower drive motor 375 are both hydraulic motors, though other motors such as electric motors, pneumatic motors, or the like, are also within the scope of the disclosure. In this example, the upper drive motor 373 and the lower drive motor 375 are hydraulically driven by a hydraulic pressure source linked by hydraulic lines 391 to the transmission line drive assembly 360.

In some embodiments the transmission line drive assembly 360 may further include a hold down system, such as a hydraulic clamp cylinder, linked to the hydraulic pressure source by a hydraulic line. The hydraulic clamp cylinder generates a predetermined normal force on the transmission line 110 between the upper and lower tractor drives 322, 324. Some slip is acceptable. Too much slip can cause transmission line jacket damage. The second duct D2 may contain some irregularities, joints and bends that can keep transmission line 110 from moving smoothly. Unless an appropriate normal force is generated (not too much slip), the first component of the motive force may be inadequate to overcome the irregularities, and slip may occur too often, causing unnecessary transmission line jacket damage or insufficient first component of the motive force. On the other hand, a normal force which is too high risks crush damage to the transmission line 110, and inadequate slippage, such that column damage will be more likely to occur as the transmission line drive assembly 360 continues to move the transmission line 110 when transmission line 110 is being slowed or stopped within the second duct D2. When slip does occur under high normal force loads, transmission line jacket damage may result. By providing for a predetermined normal force with the transmission line drive assembly 360, predetermined slip levels can be monitored. This results in an appropriate level of slip, so as to not cause too many shutdowns of the line blower 118 when transmission line damage is not significantly at risk, but excessive slip is noted, and can be used to shut off the line blower 118 to prevent damage.

In some embodiments the transmission line drive assembly 360 may further include a lower drive counter which monitors movement of the lower tractor drive 324, which is indicative of the speed of transmission line drive assembly 360. Such speed monitoring is important for preventing excessive relative speed between the transmission line drive assembly 360 and the transmission line 110 during slippage. The speed may be communicated from the lower drive counter to the local controller 160 of the transmission line drive assembly 360 which receives the speed. The speed can then be communicated to the local controllers 160 of other components (e.g., the reel stand 106, the air compressor 114, etc.) or the control unit 120.

On the other hand, once the transmission line 110 enters the air block 363 through the air block lead in guide structure 3010, the pressurized air that is produced by the air compressor 114 and enters the air block 363 through the air input port 302. The integrated seal 570, in addition with other components in the air block 363, help make the air block 363 airtight, and most of the pressurized air is not lost by leaking out of the air block 363. As such, the air pressure difference created in the second duct D2 results in the second component of the motive force, namely the pull force (i.e., suction) generated by the air pressure difference in the second duct D2.

In the example shown in FIGS. 4-6, the line blower 118 further includes an adjustment assembly 368 arranged below the air block 363. The adjustment assembly 368 allows for vertical adjustment (i.e., in the Y direction) of the air block 363 and the duct clamp 364 relative to the transmission line drive assembly 360. Such vertical adjustment enables the alignment of the central axis of the air block 363 and that of the transmission line drive assembly 360 and allows for different diameter transmission lines 110 to be installed by the line blower 118. As the diameter of the transmission line 110 is varied, the location of the central axis of the transmission line 110 will vary as it exits the transmission line drive assembly 360. Such variance in height is adjusted in order to allow for proper sealing in the air block 363. In some embodiments, the adjustment assembly 368 is an adjustment knob, and the vertical adjustment is realized by rotating the adjustment knob.

As shown in FIGS. 5-6, the air block 363 is fixed to the mount frame 510 using a secure assembly 518 and a mounting seat assembly 520. The secure assembly 518 is configured to fix the air block 363 to a beam of the mount frame 510 extending in the X direction. In the example shown in FIGS. 5-6, the secure assembly 518 is a knob screw, though other forms of secure assembly are within the scope of the disclosure. The mounting seat assembly 520 is configured to fix, using screws for example, the air block 363 to another beam of the mount frame 510 extending in the X direction. As such, the air block 363 is fixed to the mount frame 510.

On the other hand, as shown in FIGS. 4-6, the transmission line drive assembly 360 is slidably mounted to the mount frame 510. In the example shown in FIGS. 4-6, the transmission line drive assembly 360 is mounted to a top surface of a transmission line drive assembly mount plate 512 by for example screws. A pair of transmission line drive assembly mount bearing glides 514 are mounted to a bottom surface of the transmission line drive assembly mount plate 512 by for example screws. As such, there is no relative movement between the transmission line drive assembly 360 and the pair of transmission line drive assembly mount bearing glides 514. A corresponding pair of transmission line drive assembly mount bearing glide tracks 516 are mounted to a top surface of a transmission line drive assembly mount bearing glide track seating plate 522, which is fixed to the mount frame 510 or an integral portion of the mount frame 510. As such, there is no relative movement between the mount frame 510 and the transmission line drive assembly mount bearing glide track seating plate 522.

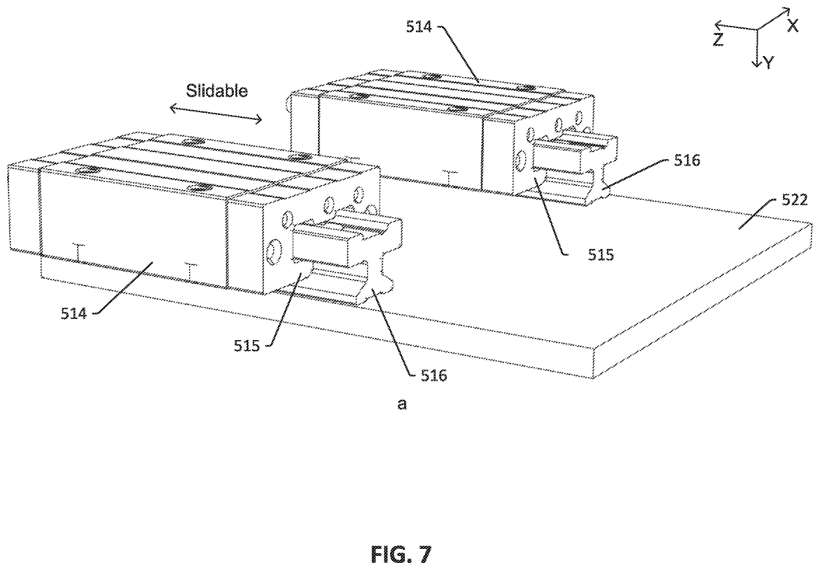

FIG. 7 is a side perspective view illustrating the engagement between the transmission line drive assembly mount bearing glides 514 and corresponding transmission line assembly mount bearing glide tracks drive . As shown in FIG. 7, the transmission line drive assembly mount bearing glides 514 can slide in the Z direction relative to the corresponding transmission line drive assembly mount bearing glide tracks 516. In one implementation, the transmission line drive assembly mount bearing glides 514 have linear bearings, and the linear bearings may use for example recirculating ball bearings. Other linear bearing structures are also within the scope of the disclosure. Accordingly, the transmission line drive assembly 360 is slidably mounted to the mount frame 510 and is capable of moving in the Z direction relative to the mount frame 510.

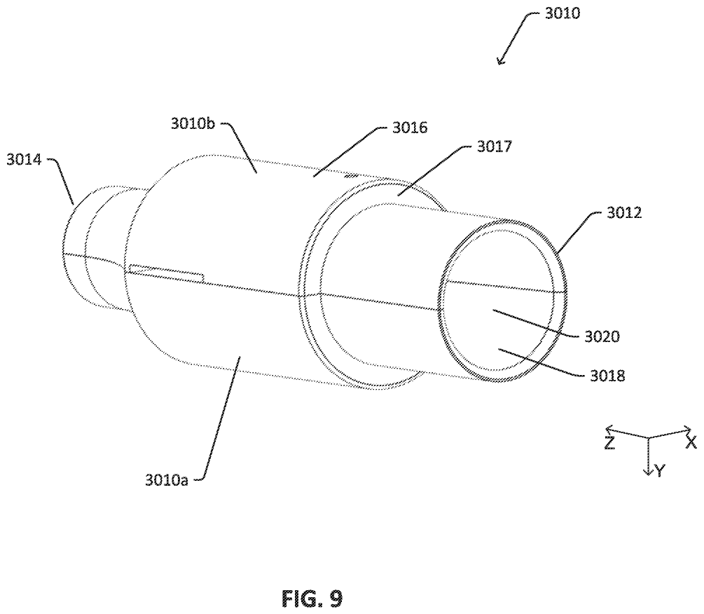

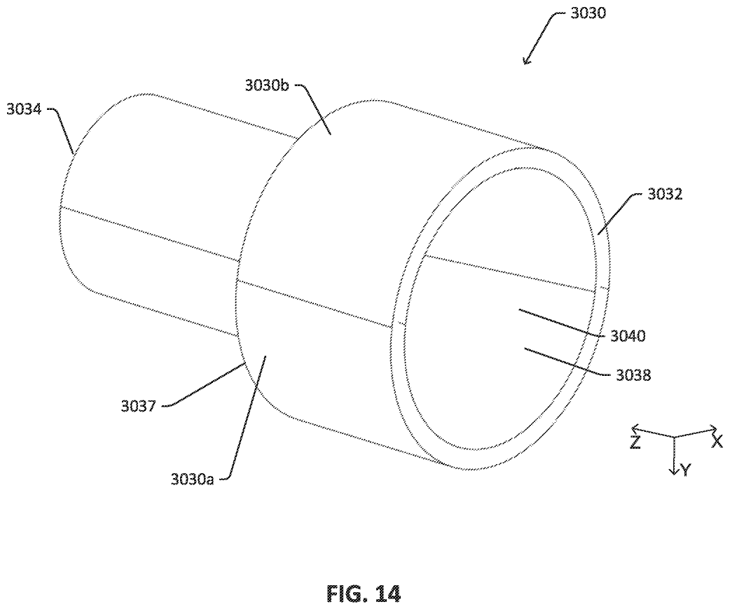

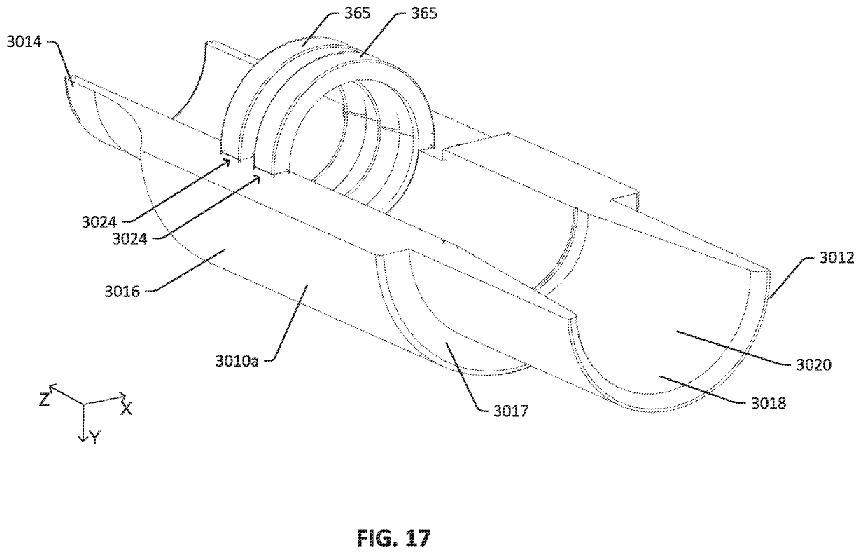

As stated above, the blower lead in guide structure 3030 and the air block lead in guide structure 3010 shown in FIG. 4 facilitate the smooth advancing of the transmission line 110. In one embodiment, the air block lead in guide structure 3010 is a venturi lead in guide structure. Specifically, FIG. 8 illustrates the relationship between the blower lead in guide structure 3030 and the air block lead in guide structure 3010. FIGS. 9-13 illustrate the air block lead in guide structure 3010 and a lower half thereof. FIGS. 14-16 illustrate the blower lead in guide structure 3030. FIG. 17 illustrates the engagement between a portion of the air block lead in guide structure 3010 of FIG. 8 and two seals.

As will be described below, both the blower lead in guide structure 3030 and the air block lead in guide structure 3010 have a tapered (funnel-shaped) cross-sectional shape that is larger at the front and decreases in size toward the end. In other words, the tapered cross-sectional shape is facing the advancement direction of the transmission line 110. Therefore, the blower lead in guide structure 3030 and the air block lead in guide structure 3010 guide the leading end of the transmission line 110 toward the transmission line drive assembly 360 and the air block 363, respectively.

Due to the tapered cross-sectional shape of the blower lead in guide structure 3030 and the air block lead in guide structure 3010, the transmission line 110 may be fed in the transmission line drive assembly 360 and the air block 363 smoothly without manual intervention, thus reducing the risk of damaging structures such as the transmission line 110 itself, structures or components in the transmission line drive assembly 360 and the air block 363, and so on. The guide system composed of the blower lead in guide structure 3030 and the air block lead in guide structure 3010 may further improve the overall performance of a transmission line conveying system 104 with multiple line blowers, as the situation shown in FIG. 4.

FIG. 8 is a side perspective view of the blower lead in guide structure 3030, the air block lead in guide structure 3010, the first duct D1, the second duct D2, and the transmission line 110. A cable guide cone 111 is attached to the leading end of the transmission line 110. In the example shown in FIG. 8, the cable guide cone 111 has a cone shape, although other streamlined shapes are within the scope of the disclosure. The cable guide cone 111 may not only lower the friction drag between the transmission line 110 and the air but also protect the leading end of the transmission line 110 from damages. It should be noted that only a portion of the transmission line 110 is illustrated in FIG. 8 for clarity so that details of the blower lead in guide structure 3030 can be easily seen. In other words, a portion of the transmission line 110 that goes through the blower lead in guide structure 3030 is not illustrated in FIG. 8.

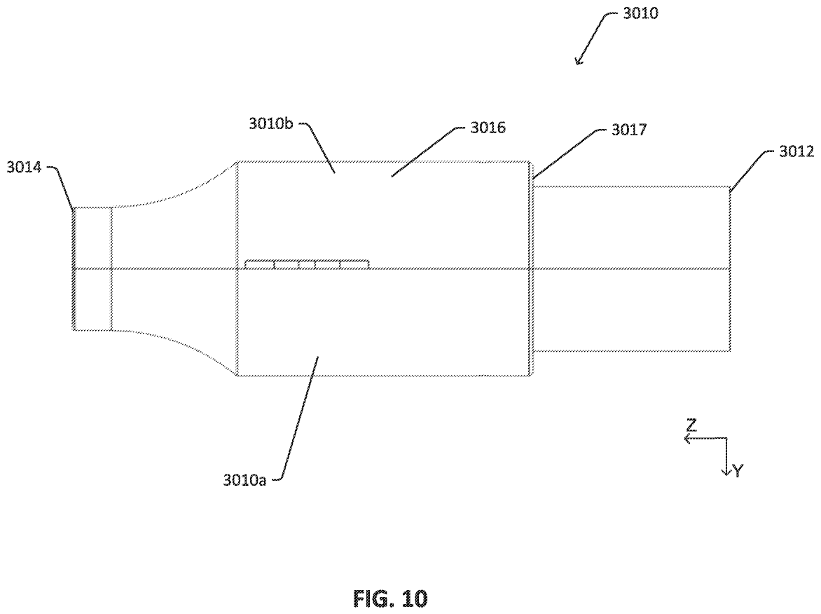

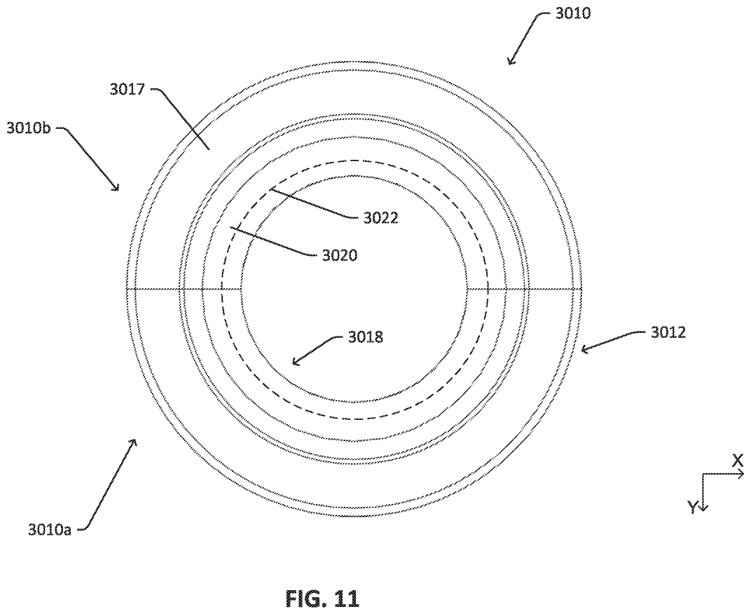

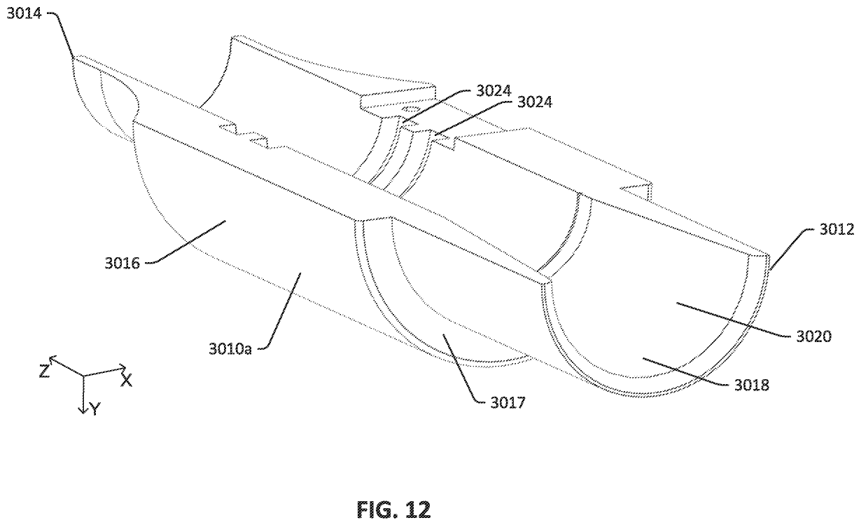

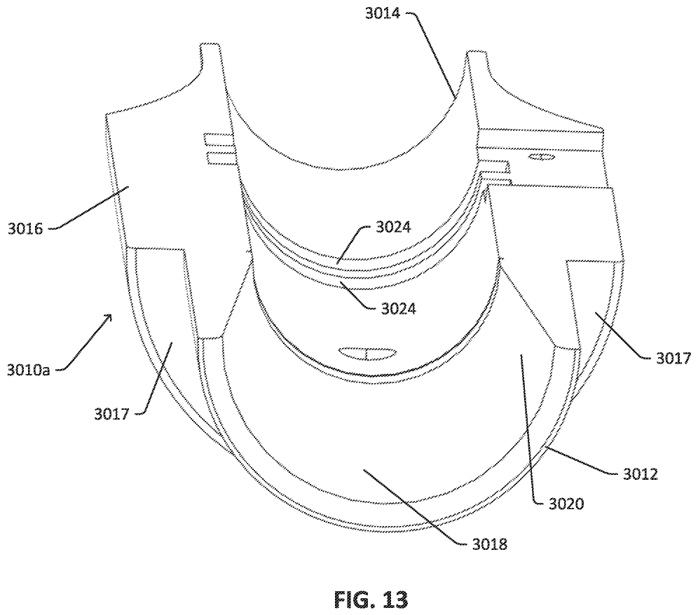

FIG. 9 is a side perspective view of the air block lead in guide structure 3010. FIG. 10 is a side view of the air block lead in guide structure 3010. FIG. 11 is a front view of the air block lead in guide structure 3010. FIG. 12 is a side perspective view of the lower half 3010a of the air block lead in guide structure 3010. FIG. 13 is a front perspective view of the lower half 3010a of the air block lead in guide structure 3010.

In some embodiments the air block lead in guide structure 3010 has two halves: a lower half 3010a and an upper half 3010b (alternatively referred to herein as a first half and a second half). As such, the air block lead in guide structure 3010 can be opened to separate the lower half 3010a and the upper half 3010b, such as to provide access into the interior of the air block lead in guide structure 3010, or to permit the transmission line 110 to be inserted or removed. For example, the lower half 3010a and the upper half 3010b can be separated during maintenance or in the event of a malfunction (e.g., damage of the transmission line 110). Additionally, the air block lead in guide structure 3010 may be replaceable. The air block lead in guide structure 3010 is made of a material that does not significantly deform with the impact of the transmission line 110. The material is more rigid than the seal 365 of FIG. 17, which will be described below. In one non-limiting example, the air block lead in guide structure 3010 is made of aluminum. In another non-limiting example, the air block lead in guide structure 3010 is made of plastic, especially a wear resistant plastic.

The air block lead in guide structure 3010 in this example include, among other things, a central portion 3016, a forward end 3012, and a rearward end 3014. The central portion 3016 has a larger size, in the X-Y plane, than those of the forward end 3012 and the rearward end 3014. As such, there is a securing flange 3017 formed at the place where the central portion 3016 and the forward end 3012 are joined. The securing flange 3017 can be used to secure the air block lead in guide structure 3010 to the transmission line input aperture of the air block 363. The rearward end 3014 has a gradual shape that may facilitate the air to flow smoothly inside the air block 363 toward the second duct D2. As a result, turbulence or laminar flow may be avoided.

The air block lead in guide structure 3010 further includes an inner body 3018. The inner body 3018 has a tapered sidewall 3020 and defines an inner aperture 3022 that extends from the forward end 3012 to the rearward end 3014. The inner aperture 3022 has a dimension at the forward end 3012 that is greater than the dimension at the place where the forward end 3012 and the central portion 3016 are joined together (i.e., the location of the securing flange 3017). A smooth gradually tapered shape, facing the advancement direction of the transmission line (for example, having a tapered cross-sectional shape that decreases in size in an advancement direction of the transmission line), of the inner aperture 3022 and the tapered sidewall 3020 acts like a funnel to direct the transmission line into the air block.

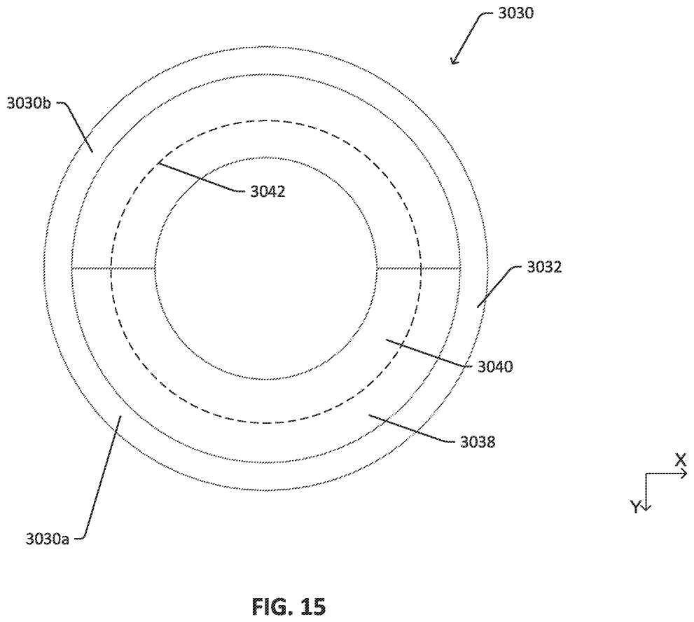

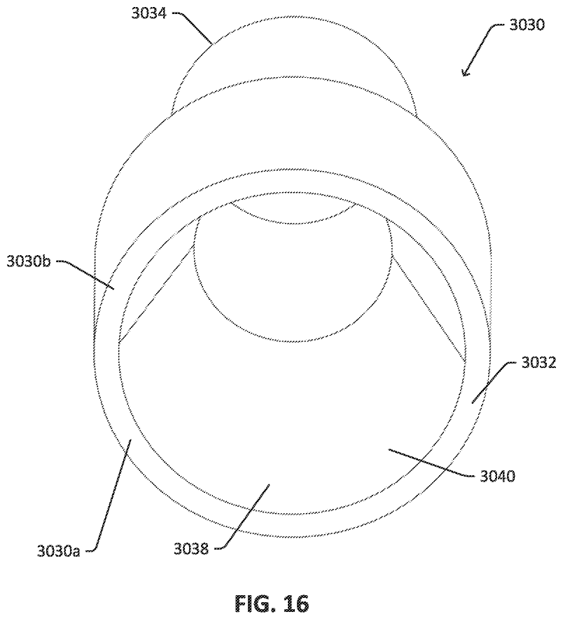

FIG. 14 is a side perspective view of the blower lead in guide structure 3030. FIG. 15 is a front view of the blower lead in guide structure 3030. FIG. 16 is a front perspective view of the blower lead in guide structure 3030.

Similarly, the blower lead in guide structure 3030 has two halves: a lower half 3030a and an upper half 3030b. As such, the blower lead in guide structure 3030 can be opened for similar reasons as the air block lead in guide structure 3010 described above. The blower lead in guide structure 3030 may be replaceable. The blower lead in guide structure 3030 is made of a material that does not significantly deform with the impact of the transmission line 110. The material is more rigid than the seal 365 of FIG. 17, which will be described below. In one non-limiting example, the blower lead in guide structure 3030 is made of aluminum. In another non-limiting example, the blower lead in guide structure 3030 is made of plastics, especially wear resistant plastics.

The blower lead in guide structure 3030 in this example include, among other things, a forward end 3032, and a rearward end 3034. The forward end 3032 has a larger size, in the X-Y plane, than that of the rearward end 3034. As such, there is a securing flange 3037 formed at the place where the rearward end 3034 and the forward end 3032 are joined together. In some embodiments the securing flange 3037 can be used to secure the blower lead in guide structure 3030 to a transmission line receptacle to prevent the blower lead in guide structure 3030 from moving rearward (along the advancement direction of the transmission line) as it passes therethrough.

The blower lead in guide structure 3030 further includes an inner body 3038. The inner body 3038 has a tapered sidewall 3040 and defines an inner aperture 3042 that extends from the forward end 3032 to the rearward end 3034. The inner aperture 3042 has a dimension at the forward end 3032 that is greater than the dimension at the place where the forward end 3032 and the rearward end 3034 are joined together (i.e., the location of the securing flange 3037). A smooth gradually tapered shape, facing the advancement direction of the transmission line (for example, having a tapered cross-sectional shape that decreases in size in an advancement direction of the transmission line), of the inner aperture 3042 and the tapered sidewall 3040 acts like a funnel to direct the transmission line into the transmission line drive assembly 360.

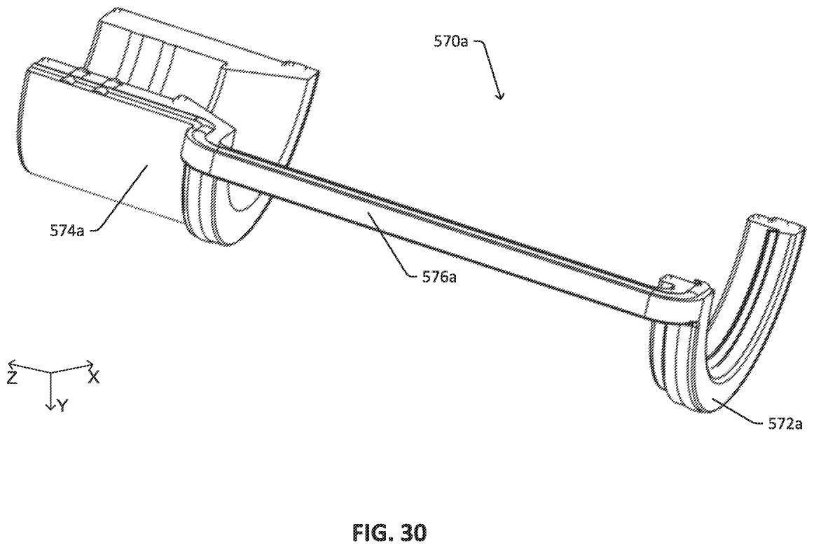

FIG. 17 illustrates the engagement between a portion of the air block lead in guide structure of FIG. 8 and two seals 365. As shown in the example of FIGS. 12-13, the central portion 3016 of the air block lead in guide structure 3010 has two seal recesses 3024 for accommodating seals 365, respectively. The seals 365 operate to prevent compressed air within the air block 363 of FIG. 30 from escaping around the transmission line 110. The seals 365 fill a gap between the air block lead in guide structure 3010 and the transmission line 110. In one embodiment, the seals 365 are flexible seals, each of which has a flexible inner body that can accommodate transmission lines of various cross-sectional shapes. In another embodiment, the seals 365 are rotational seals, each of which has a shape that corresponds to the exterior cross-sectional shape of a transmission line, and is particularly suited for transmission lines that have an orientation of a cross-sectional shape that rotates along a length of the transmission line. As such, the rotational seals are mounted so that they can rotate as the transmission line passes through it, so that a good seal can be maintained in all orientations of the cross-sectional shape. It should also be noted that the arrangement of two seal recesses 3024 and two corresponding seals 365 is just one example for illustration, and other numbers (e.g. one, three, and so on) of seal recesses 3024 and corresponding seals 365 are within the scope of the disclosure.

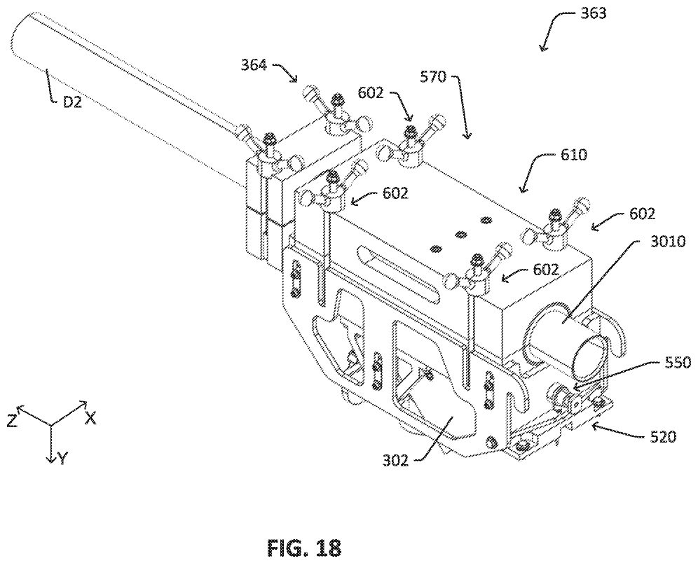

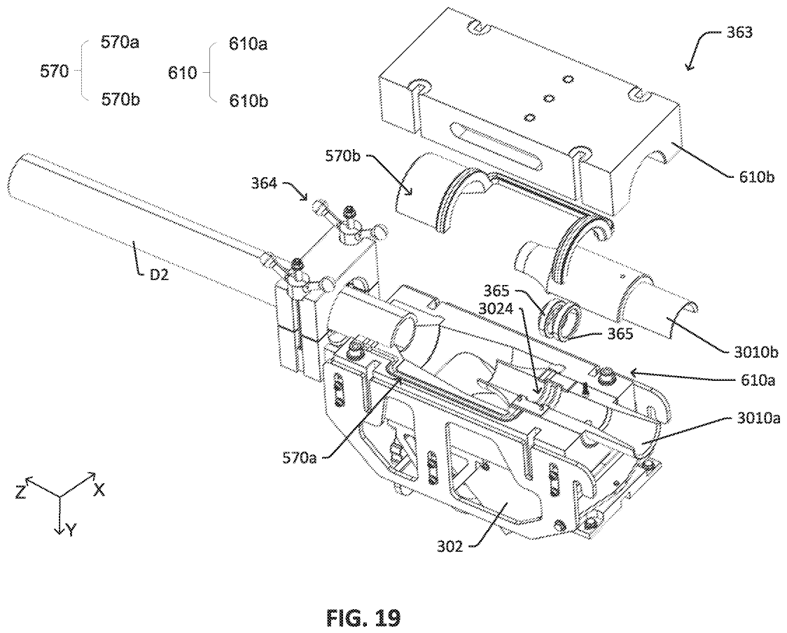

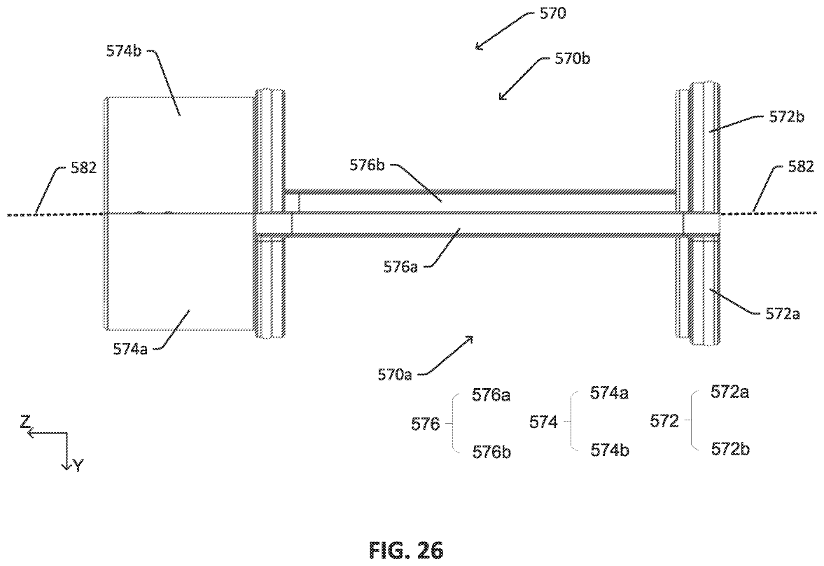

FIG. 18 is a side perspective view of the air block 363 of FIG. 4. FIG. 19 is an exploded view of the air block 363 of FIG. 4. In the example of FIGS. 18 and 19, the air block 363 includes, among other things, an air block housing 610. The air block housing 610 may accommodate components such as the integrated seal 570, the air block lead in guide structure 3010, and the like, and protect the transmission line advancing through the air block 363. The air block housing 610 includes an air block lower housing 610a and an air block upper housing 610b, which mate with each other in the X-Z plane (i.e., a central horizontal plane 582 as shown and explained in FIG. 26 below). A number of air block clamps 602 are configured to adjust the compression applied to the air block lower housing 610a and the air block upper housing 610b, to facilitate the creation of the airtightness of the air block 363.

As shown in the example of FIG. 19, the integrated seal 570 may in some embodiments include two halves: an integrated seal lower half 570a and an integrated seal upper half 570b. As described above, the air block lead in guide structure 3010 may also have two halves: the lower half 3010a and the upper half 3010b. The air block lower housing 610a, the integrated seal lower half 570a, and the lower half 3010a of the air block lead in guide structure 3010 are configured to engage with each other. Likewise, the air block upper housing 610b, the integrated seal upper half 570b, and the upper half 3010b of the air block lead in guide structure 3010 are configured to engage with each other. The seals 365 of FIG. 17 are located in seal recesses of the air block lead in guide structure 3010 and fill a gap between the air block lead in guide structure 3010 and the transmission line. The integrated seal 570 fills a gap between the air block lead in guide structure 3010 and the air block housing 610. The integrated seal 570 similarly fills another gap between the second duct D2 and the air block housing 610. As a result, the integrated seal 570 operates to prevent compressed air within the air block 363 from escaping through those potential gaps, therefore improving the airtightness of the air block 363.

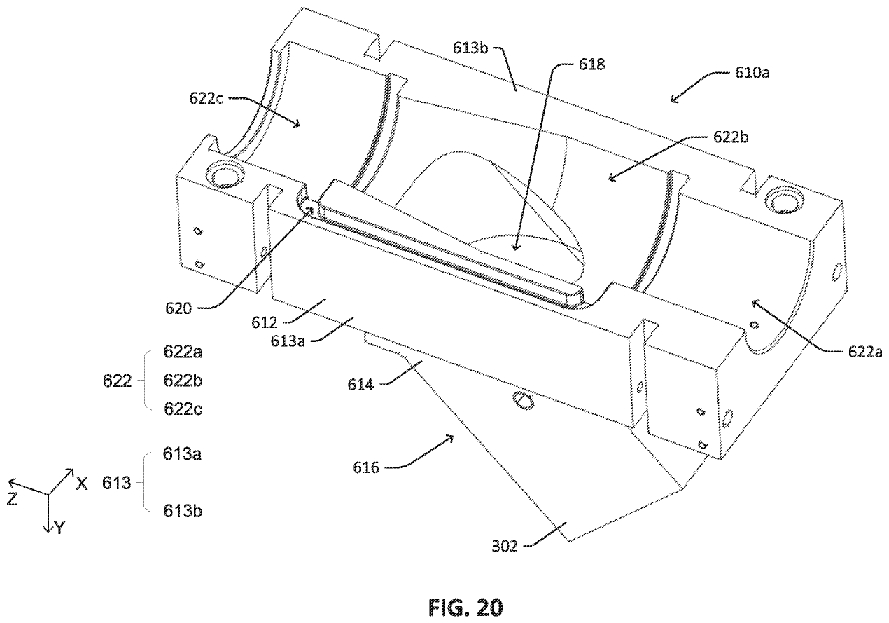

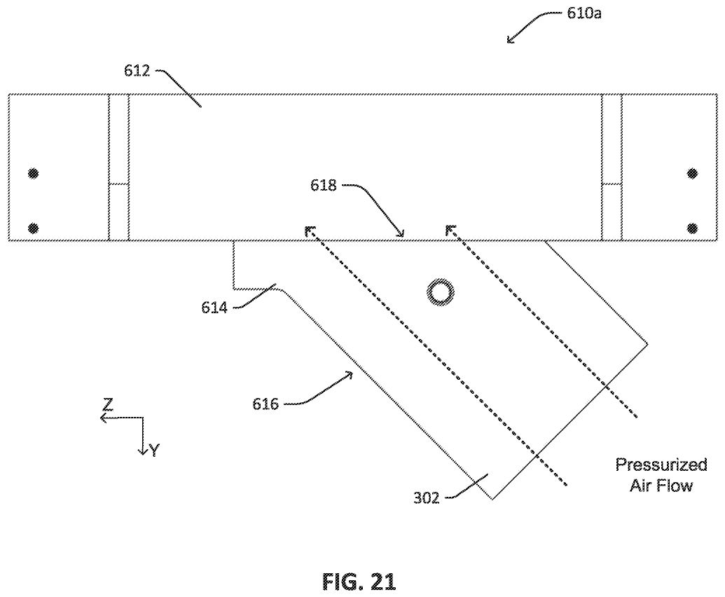

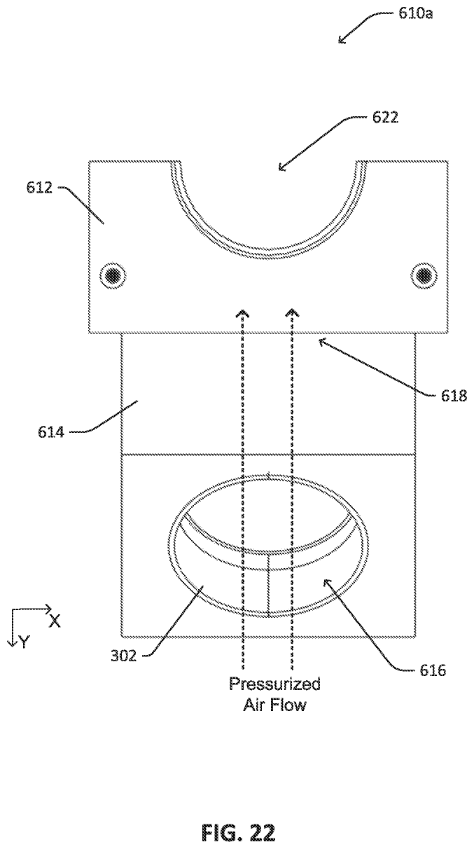

FIG. 20 a side perspective view of the air block lower housing 610a of FIG. 18. FIG. 21 is a side view of the air block lower housing 610a of FIG. 18. FIG. 22 is a front view of the air block lower housing 610a of FIG. 18. The air block lower housing 610a includes, among other things, an air block lower housing body 612 and an air input base 614. In some embodiments, the air block lower housing body 612 and an air input base 614 may be separate structures secured together using for example screws. In some embodiments, the air block lower housing body 612 and an air input base 614 may be an integral structure. The air input base 614 includes an air passage 616 connecting the air input port 302, where the pressurized air produced by the air compressor enters the air block 363, and an air block intake port 618. The air block intake port 618 is located in the X-Z plane where the air input base 614 and the air block lower housing body 612 are joined together. As such, the pressurized air produced by the air compressor enters the air block 363 through the air passage 616. The pressurized air flow is illustrated as the dash lines with arrows in FIGS. 21 and 22.

The air block lower housing body 612 has an air block lower chamber 622 extending in the Z direction. The air block lower chamber 622 generally has a U-shaped profile in the X-Y plane, though the cross sections in the X-Y planes across the Z direction vary. The air block lower chamber 622 has three portions: a front portion 622a, a middle portion 622b, and a rear portion 622c. The front portion 622a of the air block lower chamber 622 is configured to accommodate a portion of the air block lead in guide structure 3010, as shown in FIG. 19. The rear portion 622c of the air block lower chamber 622 is configured to accommodate the integrated seal 570 and the proximal end of the second duct D2, as shown in FIG. 19. The middle portion 622b of the air block lower chamber 622 is connected to the air block intake port 618.

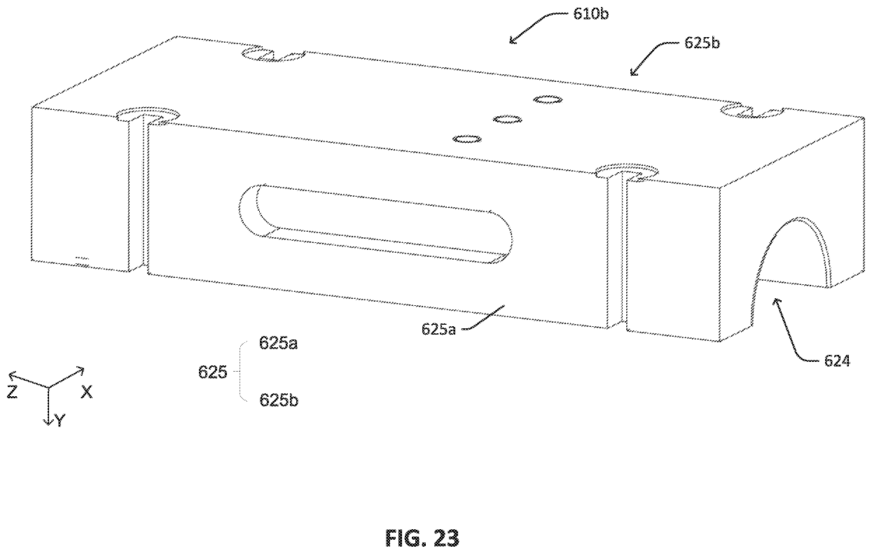

The air block lower housing body 612 has corresponding front portion, middle portion, and rear portion. The air block lower housing body 612 has two sidewalls 613: a left sidewall 613a and a right sidewall 613b, each of which has corresponding front portion, middle portion, and rear portion. A lower housing seal accommodating recess 620 is located at the middle portion of the left sidewall 613a. The lower housing seal accommodating recess 620 is configured to accommodate the integrated seal 570, and more specifically a left strip 576a of a connecting sealing member 576 of the integrated seal 570, which will be described below in detail with reference to FIGS. 23. The lower housing seal accommodating recess 620 has a depth, in the Y direction, that is smaller than the height, in the Y direction, of the left strip 576a of the connecting sealing member 576 of the integrated seal 570. As such, the left strip 576a of the connecting sealing member 576 of the integrated seal 570 has to be pressed in the Y direction when inserted into the lower housing seal accommodating recess 620, therefore improving the airtightness of the air block 363 and eliminating the impact of any potential gaps between the air block lower housing 610a and the air block upper housing 610b.

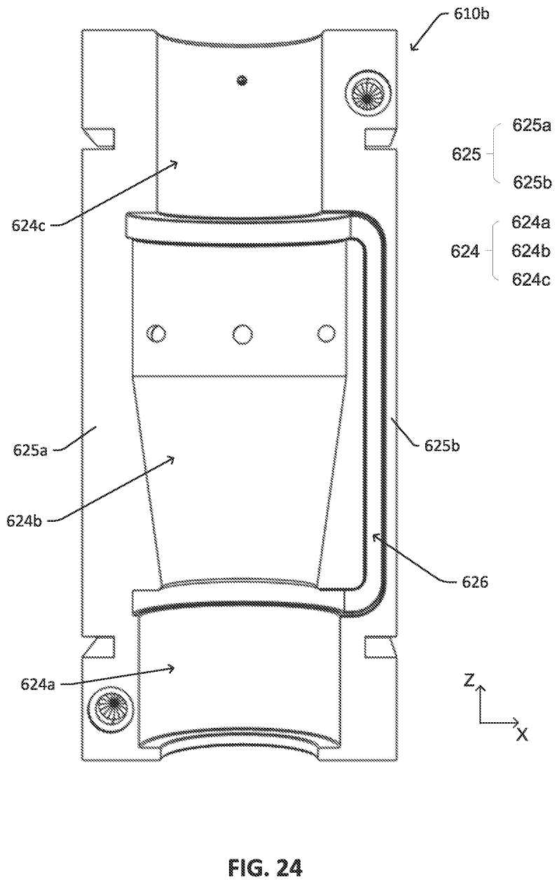

FIG. 23 a side perspective view of the air block upper housing 610b of FIG. 18. FIG. 24 is a bottom view of the air block upper housing 610b of FIG. 18. The air block upper housing 610b has an air block upper chamber 624 extending in the Z direction.

The air block upper chamber 624 generally has a U-shaped profile in the X-Y plane, though the cross sections in the X-Y planes across the Z direction vary. The air block upper chamber 624 has three portions: a front portion 624a, a middle portion 624b, and a rear portion 624c, corresponding to the three portions of the air block lower chamber 622. The front portion 624a of the air block upper chamber 624 is configured to accommodate a portion of the air block lead in guide structure 3010, as shown in FIG. 19. The rear portion 624c of the air block upper chamber 624 is configured to accommodate the integrated seal 570 and the proximal end of the second duct D2, as shown in FIG. 19.

The air block upper housing 610b has corresponding front portion, middle portion, and rear portion. The air block upper housing 610b has two sidewalls 625: a left sidewall 625a and a right sidewall 625b, each of which has corresponding front portion, middle portion, and rear portion. An upper housing seal accommodating recess 626 is located at the middle portion of the right sidewall 625b. The upper housing seal accommodating recess 626 is configured to accommodate the integrated seal 570, and more specifically a right strip 576b of a connecting sealing member 576 of the integrated seal 570, which will be described below in detail with reference to FIG. 23. The upper housing seal accommodating recess 626 has a depth, in the Y direction, that is smaller than the height, in the Y direction, of the right strip 576b of the connecting sealing member 576 of the integrated seal 570. As such, the right strip 576b of the connecting sealing member 576 of the integrated seal 570 has to be pressed in the Y direction when inserted into the upper housing seal accommodating recess 626, therefore improving the airtightness of the air block 363 and eliminating the impact of any potential gaps between the air block lower housing 610a and the air block upper housing 610b.

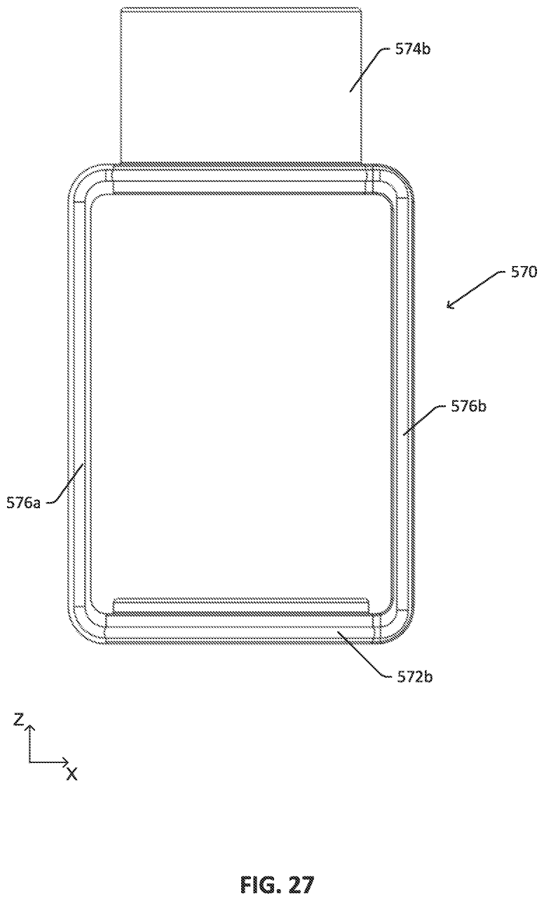

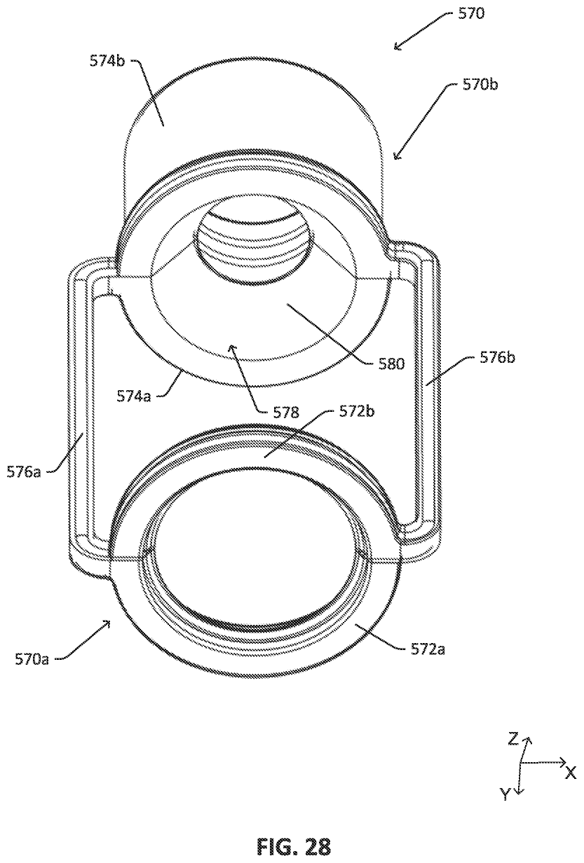

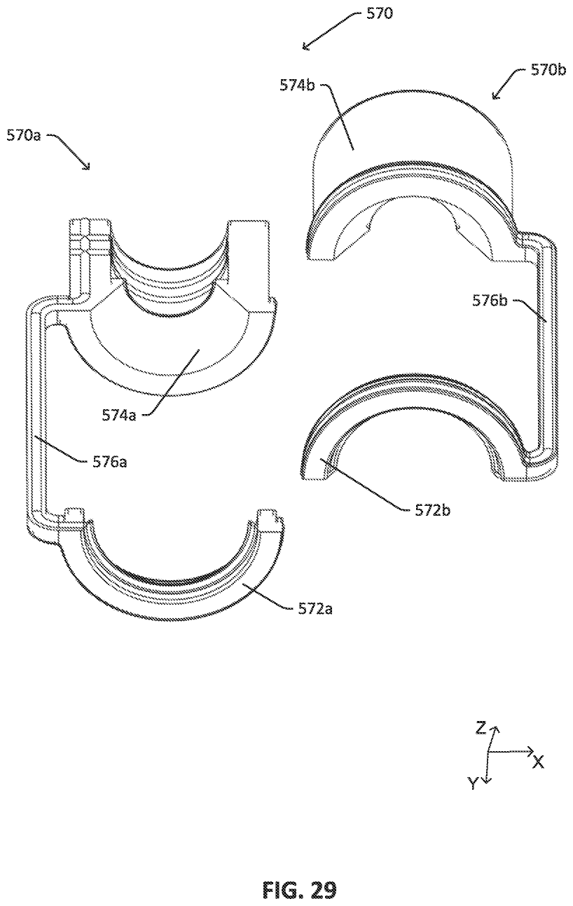

FIG. 25 a side perspective view of the integrated seal 570 of FIG. 18. FIG. 26 is a side view of the integrated seal 570 of FIG. 18. FIG. 27 is a top view of the integrated seal 570 of FIG. 18. FIG. 28 is a front perspective view of the integrated seal 570 of FIG. 18. FIG. 29 is a front perspective view of the integrated seal lower half 570a and the integrated seal upper half 570b of the integrated seal 570 of FIG. 18.

As shown in FIGS. 25-28, the integrated seal 570 has a front sealing member 572, a rear sealing member 574, and a connecting sealing member 576 connecting the front sealing member 572 and the rear sealing member 574. When engaged with the air block housing 610, the front sealing member 572 is at the location where the front portion 622a and the middle portion 622b of the air block lower chamber 622 join together, and the rear sealing member 574 is configured to engage with the rear portion 622c of the air block lower chamber 622.

The front sealing member 572 is a ring-shaped sealing member. The front sealing member 572 fills a gap between the air block lead in guide structure 3010 and the air block housing 610. In the embodiments where the integrated seal 570 has the integrated seal lower half 570a and the integrated seal upper half 570b, the front sealing member 572 has the lower half 572a and the upper half 572b.

The rear sealing member 574 is a hollow cylindrical sealing member. The rear sealing member 574 and the front sealing member 572 share a central axis extending in the Z direction. The rear sealing member 574 fills a gap between the second duct D2 and the air block housing 610. The exterior of the rear sealing member 574 is a cylindrical surface. The interior of the rear sealing member 574 has a tapered (funnel-shaped) cross-sectional shape that is larger at the front and decreases in size toward the end. In other words, the tapered cross-sectional shape is facing the advancement direction of the transmission line. The rear sealing member 574 has an inner body 578, which has a tapered sidewall 580. A smooth gradually tapered shape and the tapered sidewall 580 acts like a funnel to direct the transmission line into the second duct D2. Therefore, the rear sealing member 574 is configured to guide the leading end of the transmission line toward the second duct D2. In the embodiments where the integrated seal 570 has the integrated seal lower half 570a and the integrated seal upper half 570b, the rear sealing member 574 has the lower half 574a and the upper half 574b.

The connecting sealing member 576 is configured to connect the front sealing member 572 and the rear sealing member 574, therefore forming an integral sealing structure (i.e., the integrated seal 570). The connecting sealing member 576 fills potential gaps between the air block lower housing 610a and air block upper housing 610b. In the example shown in FIGS. 25-28, the connecting sealing member 576 has a left strip 576a and a right strip 576b. The left strip 576a is U-shaped and is configured to connect the left side of the front sealing member 572 and the left side of the rear sealing member 574; the right strip 576b is U-shaped and is configured to connect the right side of the front sealing member 572 and the right side of the rear sealing member 574. The elongated middle portion of the U-shaped left strip 576a is extending in the Z direction; the elongated middle portion of the U-shaped right strip 576b is extending in the Z direction. As shown in FIG. 26, the left strip 576a and the right strip 576b are not in the same horizontal plane (i.e., X-Z plane). The left strip 576a is below and abutting the central horizontal plane 582, whereas the right strip 576b is above and abutting the central horizontal plane 582. The central horizontal plane 582 contains the shared central axis of the front sealing member 572 and the rear sealing member 574.

In some embodiments, the integrated seal 570 is a one-piece (i.e., integral) structure. As shown in FIG. 29, the integrated seal 570 in some embodiments can have two separate halves: the integrated seal lower half 570a and the integrated seal upper half 570b. The integrated seal lower half 570a includes the lower half 572a of the front sealing member 572, the lower half 574a of the rear sealing member 574, and the left strip 576a of the connecting sealing member 576. The integrated seal upper half 570b includes the upper half 572b of the front sealing member 572, the upper half 574b of the rear sealing member 574, and the right strip 576b of the connecting sealing member 576. Having two separate halves makes it easier to open the air block housing 610 or the integrated seal 570 in situations such as maintenance, repairment, transmission line damage, or the like.

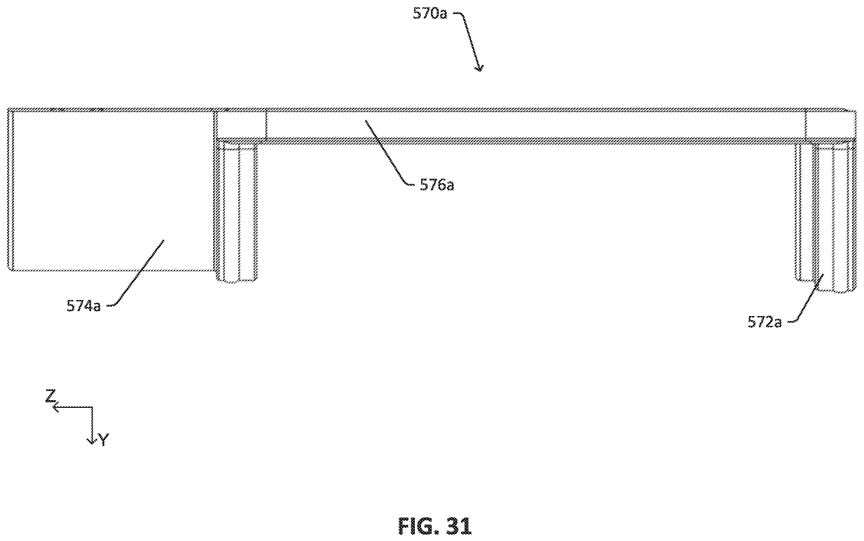

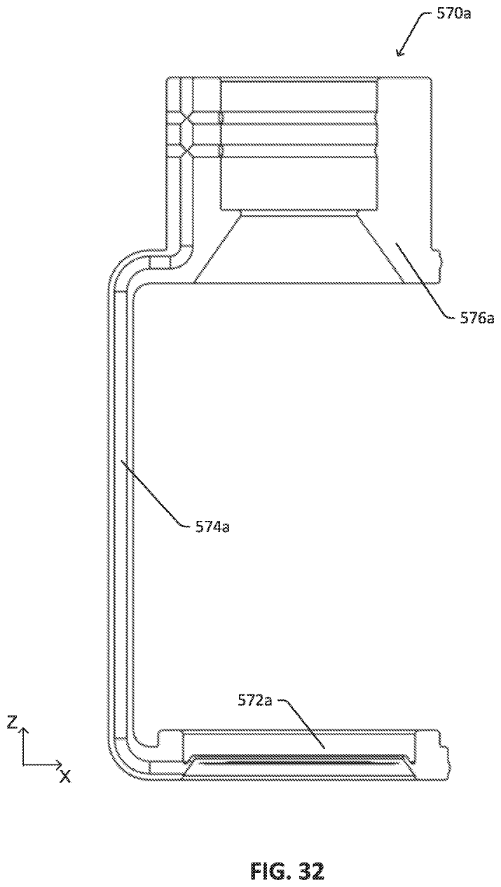

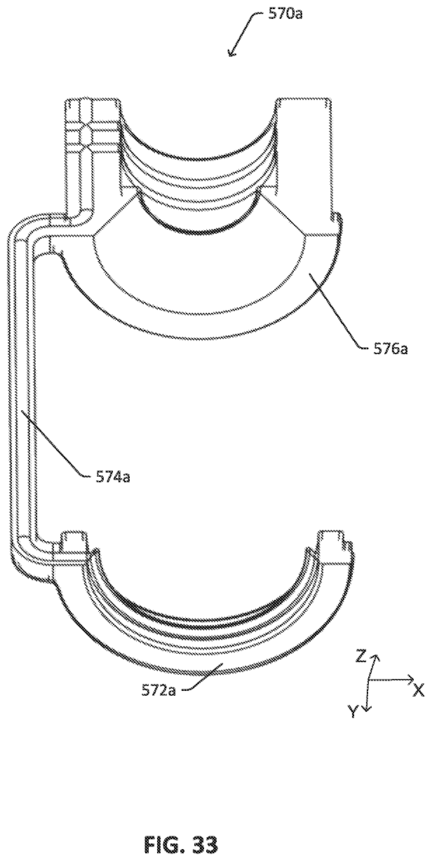

FIG. 30 is a side perspective view of the integrated seal lower half 570a of FIG. 19. FIG. 31 is a side view of the integrated seal lower half 570a of FIG. 19. FIG. 32 is a top view of the integrated seal lower half 570a of FIG. 19. FIG. 33 is a front perspective view of the integrated seal lower half 570a of FIG. 19. Details of the integrated seal lower half 570a are not repeated for simplicity.

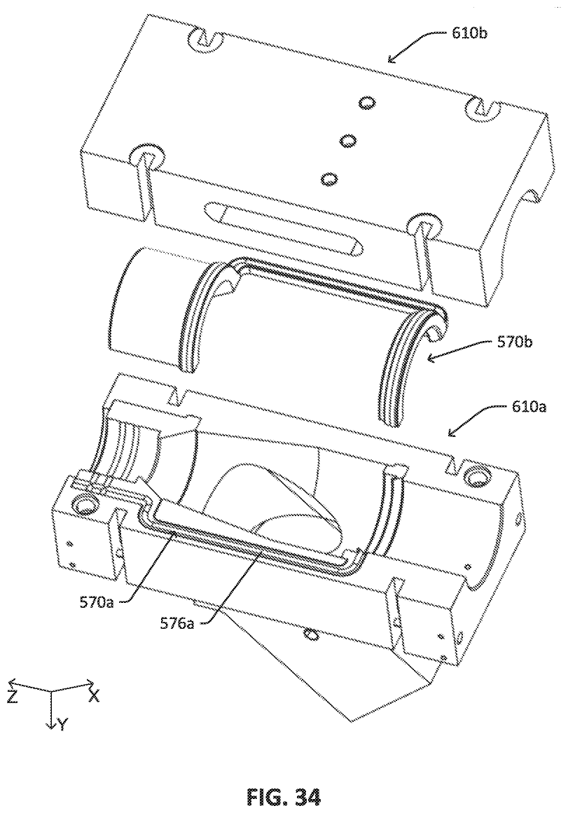

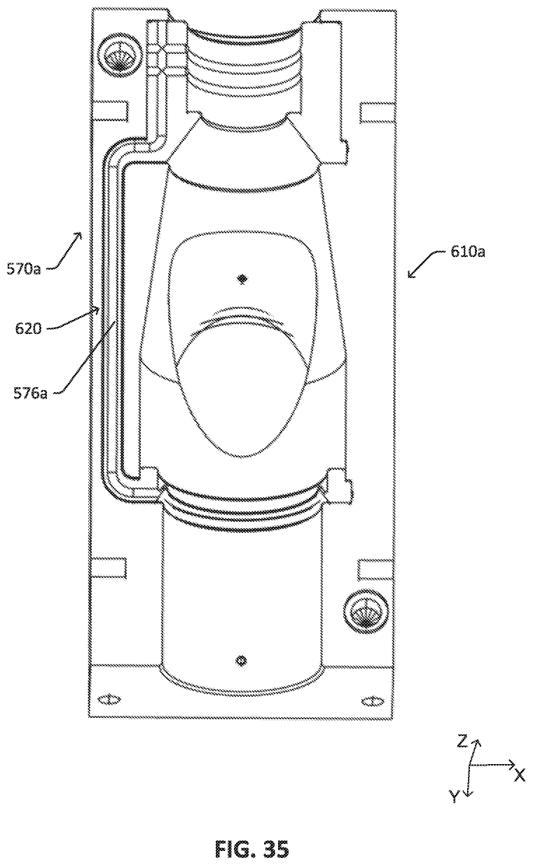

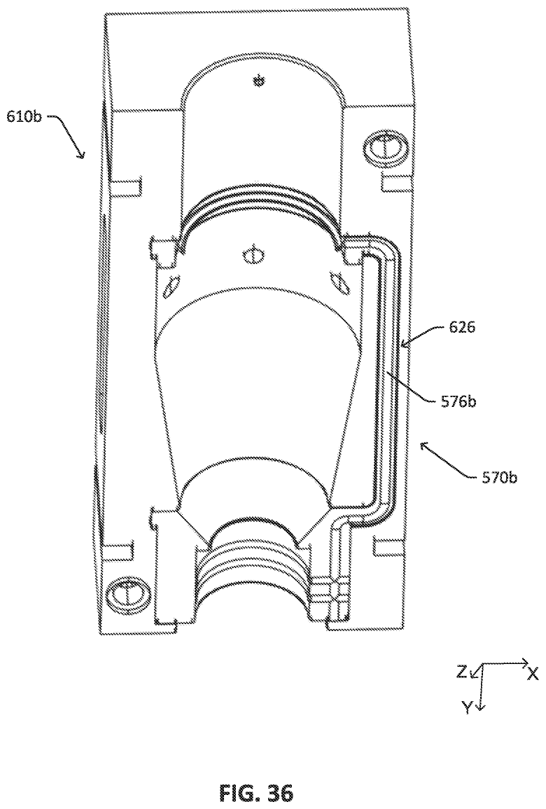

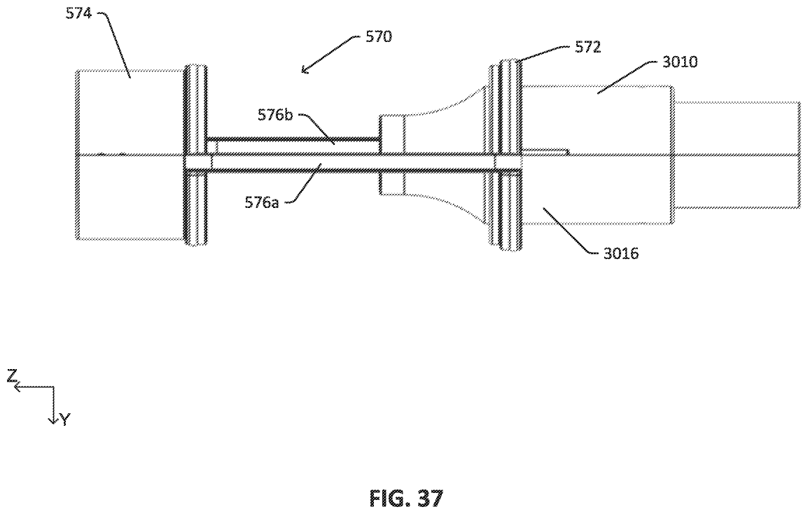

FIG. 34 is a side perspective view of the engagement between the integrated seal 570 and the air block housing 610. FIG. 35 is a front perspective view of the engagement between the integrated seal lower half 570a and the air block lower housing 610a. FIG. 36 is a front perspective view of the engagement between the integrated seal upper half 570b and the air block upper housing 610b. FIG. 37 is a side view of the engagement between the integrated seal 570 and the air block lead in guide structure 3010.

As mentioned above, the left strip 576a of the connecting sealing member 576 is configured to engage with the lower housing seal accommodating recess 620, as shown in FIG. 35; the right strip 576b of the connecting sealing member 576 is configured to engage with the upper housing seal accommodating recess 626, as shown in FIG. 36. As shown in FIG. 37, the central portion 3016 of the air block lead in guide structure 3010 engages with the front sealing member 572, such that the front sealing member 572 fills the gap between the air block lead in guide structure 3010 and the air block housing 610.

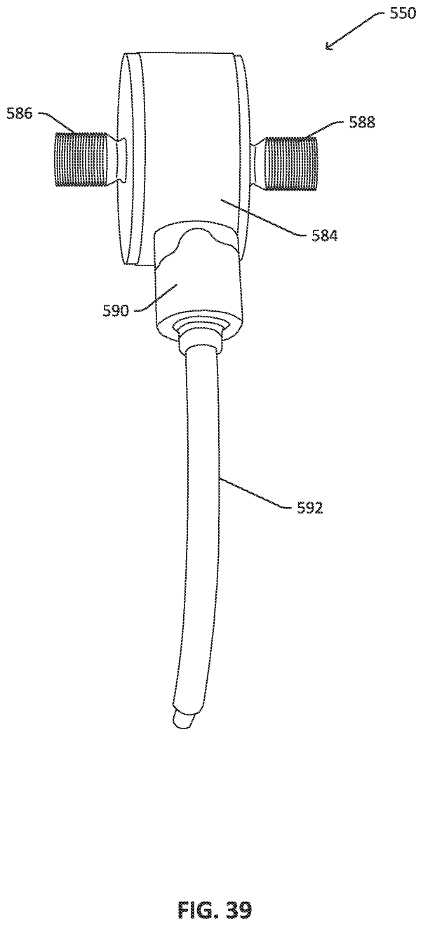

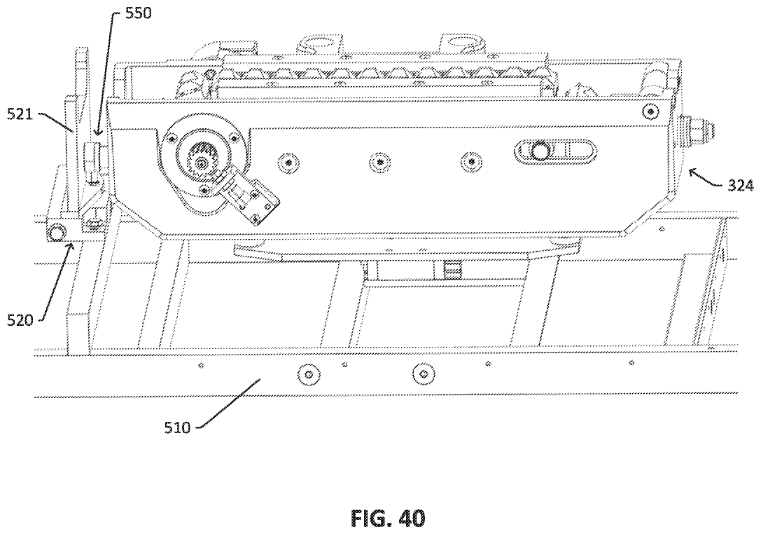

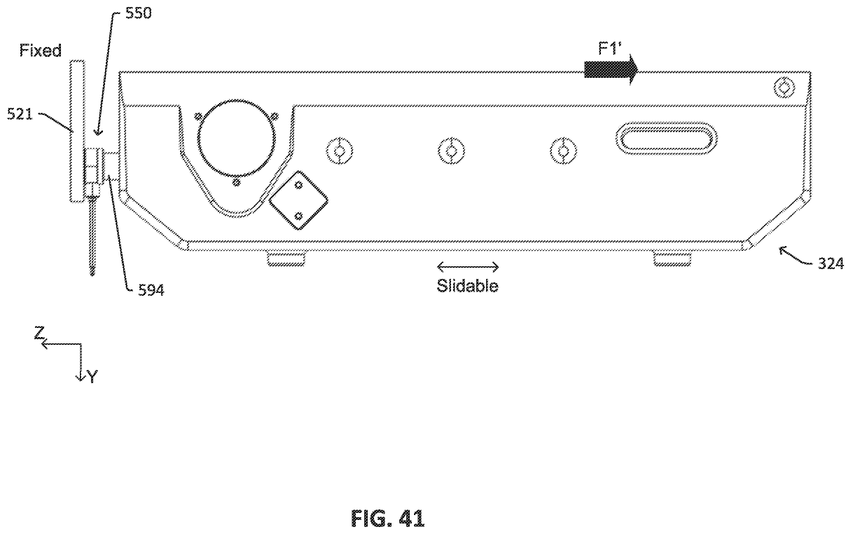

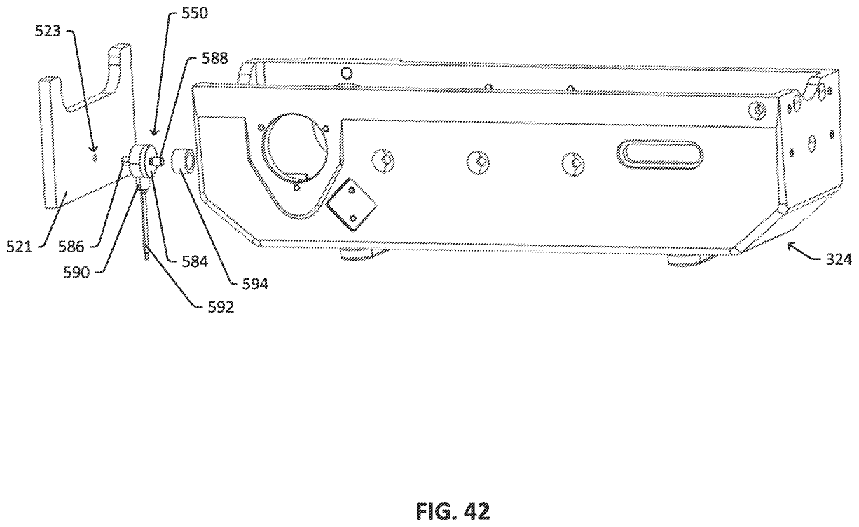

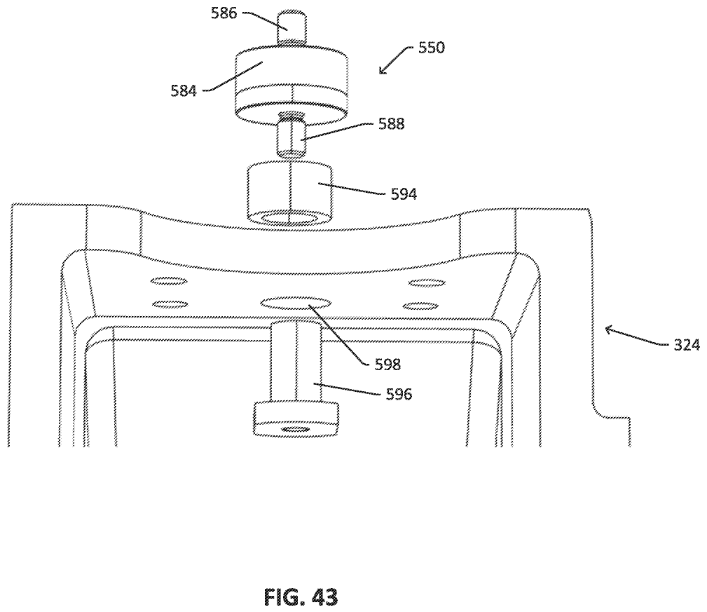

FIG. 38 is a schematic diagram illustrating the functioning of the load cell 550 of the transmission line conveying apparatus (also referred to as the line blower) 118 of FIG. 2. FIG. 39 is a diagram illustrating an example load cell 550. FIG. 40 is a side perspective view of the load cell 550, the vertical plate 521, and the lower tractor drive 324. FIG. 41 is a side view of the load cell 550, the vertical plate 521, and the lower tractor drive 324. FIG. 42 is an exploded side perspective view of the load cell 550, the vertical plate 521, and the lower tractor drive 324. FIG. 43 is a top perspective view of the engagement between the load cell 550 and the lower tractor drive 324.

As mentioned above, the line blower 118 includes, among other things, the transmission line drive assembly 360, the air block 363, and the load cell 550. The air block 363 is fixed to the mount frame 510, whereas the transmission line drive assembly 360 is slidably mounted on the mount frame 510. The transmission line drive assembly 360 may move relative to the mount frame 510, either in the direction of the advancement of the transmission line 110 or in the direction of the retreat of the transmission line 110. Therefore, the transmission line drive assembly 360 may move relative to the air block, and a displacement of the transmission line drive assembly 360 exists.

As mentioned above, both the second component F2 of the motive force, namely the pull force (i.e., suction) generated by the air pressure difference in the duct D, and the first component F1 of the motive force, namely the drive force generated by frictional engagement of the transmission line 110 with the transmission line drive assembly 360, are applied to the transmission line 110. It should be noted that the directions and relative magnitudes of the first component F1 and the second component F2 shown in FIG. 38 are for illustration and may vary under different circumstances. For instance, the first component F1 may in some embodiments in the opposite direction as shown in FIG. 38, namely in the direction of the retreat of the transmission line 110. This may occur when the line blower 118 is configured to slow down the advancement of the transmission line 110 and implemented by controlling the endless chains 323, as shown in FIG. 5, to in rotate a reverse way (i.e., clockwise rather than counterclockwise as shown in FIG. 5).

As shown in FIG. 38, as the first component F1 is applied to the transmission line 110, a reaction F1′ of the first component F1 is applied to the transmission line drive assembly 360 according to Newton's third law. Since the transmission line drive assembly 360 is slidable relative to the mount frame 510, the transmission line drive assembly 360 will have a displacement in the direction of the retreat of the transmission line 110. The transmission line drive assembly 360 is at rest when the tension between the transmission line 110 and the transmission line drive assembly 360 is equal in magnitude to the reaction F1′. Therefore, the magnitude of the tension between the transmission line 110 and the transmission line drive assembly 360 is equal to that of the first component F1. As such, the load cell 550 can measure the first component F1.

Likewise, when the first component F1 is in the opposite direction as shown in FIG. 38, the reaction F1′ is in the opposite direction as shown in FIG. 38 as well. The transmission line drive assembly 360 is at rest when the compression between the transmission line 110 and the transmission line drive assembly 360 is equal in magnitude to the reaction F1′. Therefore, the magnitude of the compression between the transmission line 110 and the transmission line drive assembly 360 is equal to that of the first component F1. As such, the load cell 550 can measure the first component F1 in this situation.

In general, a load cell is a force transducer and it is configured to convert a force such as tension, compression, pressure, or torque into an electrical signal that can be measured and standardized. As shown in FIGS. 39-43, the load cell 550 includes, among other things, a load cell body 584, a first connector 586, a second connector 588, an output port 590, an output cable 592. The first connector 586 is configured to be secured to a mounting hole 523 on the vertical plate 521, which can be considered as a portion of the air block 363. In the example shown in FIG. 39, the first connector 586 is a shaft with threads on the surface of the shaft, and the first connector 586 is secured to the mounting hole 523 by means of the threads. It should be noted that other securing arrangement between the first connector 586 and the vertical plate 521 is within the scope of the disclosure.

The second connector 588 is configured to be secured to a housing of the lower tractor drive 324 through a connecting nut 594 and an inserting nut 596. In the example shown in FIGS. 39, 42, and 43, the second connector 588 is a shaft with thread on the surface of the shaft, and the second connector 588 is secured to the inserting nut 596 by means of the threads. The inserting nut 596 has an elongated portion being inserted into an aperture 598 of the housing of the lower tractor drive 324 and a hat having a size larger than the aperture 598, as shown in FIG. 43. The elongated potion is inserted into the connecting nut 594 and being secured to the connecting nut 594 by means of for example threads, as shown in FIG. 43. It should be noted that other securing arrangement between the second connector 588 and the housing of the lower tractor drive 324 is within the scope of the disclosure.

The load cell body 584 includes inside, among other things, a strain gauge. In some embodiments, the strain gauge is constructed of very fine wire, or foil, set up in a grid pattern and attached to a flexible backing. When the shape of the strain gauge is altered, a change in its electrical resistance occurs. The wire or foil in the strain gauge is arranged in a way that, when force is applied in one direction, a linear change in resistance results. Tension force stretches a strain gauge, causing it to get thinner and longer, resulting in an increase in resistance. Compression force does the opposite. The strain gauge compresses, becomes thicker and shorter, and resistance decreases. The strain gauge is attached to a flexible backing enabling it to be easily applied to the load cell 550. In some embodiments, a set of four strain gauges are set in a specific circuit called Wheatstone bridge, which is a configuration of four balanced resistors with a known excitation voltage applied. The Wheatstone bridge arrangement of the strain gauges can magnify the relatively small changes in resistance into a voltage value that is more measurable. In some embodiments, the load cell body 584 is made of stainless steel which makes it sturdy but also minimally elastic, though it can also be made of other materials such as aluminum, alloy steel, or the like.

The output port 590 is configured to be connected to the output cable 592. The electrical signal, either a voltage signal or a current signal, is output to the local controller 160 as shown in FIG. 38, through the output cable 592 and some intermediary components such as a voltage sensor or a current sensor. As such, the local controller 160 can obtain the first component F1 of the motive force by for example reading the output signals of the load cell 550. The local controller 160 of the line blower 118 can then control the transmission line drive assembly 360 to adjust the operation parameters of the transmission line drive assembly 360 to adjust the first component F1 of the motive force based on the measured first component F1 of the motive force. As such, the load cell 550, the local controller 160 of the line blower 118, and transmission line drive assembly 360 together may provide a negative feedback loop to regulate the first component F1 of the motive force, therefore improving the smoothness and stability of the advancing transmission line 110 and avoiding potential buckling of the transmission line 110.

In one non-limiting example, the load cell 550 is a miniature sealed stainless steel load cell. The capacities of the load cell 550 may range from 1000 to 10000 lbf (pound force), namely from 4500 N to 45000 N. In another non-limiting example, the load cell 550 may operate under temperatures ranging from −54° C. to 121° C. and has the temperature compensation function between −10° C. and 45° C. It should be noted that load cells of other types, makes, or models are within the scope of the disclosure. The load cell 550 are replaceable.

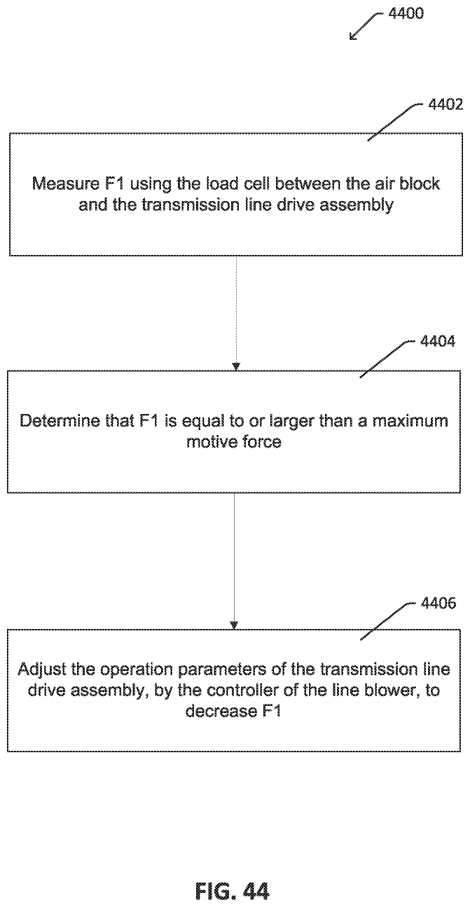

FIG. 44 is a flowchart illustrating a method 4400 of controlling the transmission line drive assembly 360 of the line blower 118 of FIG. 38. At step 4402, the first component F1 of the motive force is measured using the load cell 550 between the air block 363 and the transmission line drive assembly 360. At step 4404, it is determined that the first component F1 of the motive force is equal to or larger than a maximum motive force. At step 4406, the operation parameters of the transmission line drive assembly 360 are adjusted, by the local controller 160 of the liner blower 118, to decrease the first component F1 of the motive force until it is below the maximum motive force. In another embodiment, a similar method can be used to control the transmission line drive assembly 360 of the line blower 118 to make sure the first component F1 of the motive force is above the minimum motive force.

The present disclosure and claims sometimes utilize the words “first,” “second,” “third,” etc. as labels to particularly identify particular objects. Unless required by the context, such terms are used only as labels and do not require any particular order or arrangement with respect to each other or with respect to other objects. For example, a first segment of a duct does not need to be at the beginning of the duct and the second segment does not need to come after the first.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. An integrated seal used in an air block of a transmission line conveying apparatus comprising:
a ring-shaped front sealing member;
a hollow cylindrical rear sealing member, the hollow cylindrical rear sealing member and the ring-shaped front sealing member sharing a central axis; and
a connecting sealing member connecting the ring-shaped front sealing member and the hollow cylindrical rear sealing member.

2. The integrated seal of claim 1, wherein the connecting sealing member includes:
a left strip connecting a left side of the ring-shaped front sealing member and a left side of the hollow cylindrical rear sealing member; and
a right strip connecting a right side of the ring-shaped front sealing member and a right side of the hollow cylindrical rear sealing member.

3. The integrated seal of claim 2, wherein the left strip is U-shaped, and an elongated middle portion of the left strip extends in parallel with the central axis.

4. The integrated seal of claim 3, wherein the right strip is U-shaped, and the elongated middle portion of the right strip extends in parallel with the central axis.

5. The integrated seal of claim 4, wherein the left strip is below and abutting a central horizontal plane containing the central axis, and the right strip is above and abutting the central horizontal plane.

6. The integrated seal of claim 1, wherein an exterior of the hollow cylindrical rear sealing member has a cylindrical surface, and an interior of the hollow cylindrical rear sealing member has a tapered cross-sectional shape that decreases from a front to a middle in a direction of the central axis.

7. The integrated seal of claim 1, wherein the hollow cylindrical rear sealing member has an inner body, the inner body having a tapered sidewall.

8. The integrated seal of claim 1, wherein the integrated seal is a one-piece integrated seal.

9. The integrated seal of claim 5, wherein the integrated seal has an integrated seal lower half and an integrated seal upper half, the integrated seal lower half being below and abutting the central horizontal plane, the integrated seal upper half being above and abutting the central horizontal plane.

10. The integrated seal of claim 9, wherein the integrated seal lower half includes a lower half of the ring-shaped front sealing member, a lower half of the hollow cylindrical rear sealing member, and the left strip.

11. The integrated seal of claim 10, wherein the integrated seal upper half includes an upper half of the ring-shaped front sealing member, an upper half of the hollow cylindrical rear sealing member, and the right strip.

12. An air block of a transmission line conveying apparatus comprising:
an air block housing; and
an integrated seal located in the air block housing, the integrated seal comprising:
a ring-shaped front sealing member;
a hollow cylindrical rear sealing member, the hollow cylindrical rear sealing member and the ring-shaped front sealing member sharing a central axis; and
a connecting sealing member connecting the ring-shaped front sealing member and the hollow cylindrical rear sealing member.

13-22. (canceled)

23. The air block of claim 12, wherein the air block housing further comprises:
an air block upper housing above and abutting the central horizontal plane; and
an air block lower housing below and abutting the central horizontal plane.

24. The air block of claim 23, wherein the air block lower housing further comprises:
an air block lower housing body below and abutting the central horizontal plane, the air block lower housing body having an air block intake port at a bottom of the air block lower housing body; and
an air input base below the air block lower housing body, the air input base having an air passage connecting an air input port and the air block intake port, the air input port being configured to receive pressurized air.

25. The air block of claim 24, wherein the air block upper housing has an air block upper chamber extending in parallel with the central axis, and the air block lower housing body has an air block lower chamber extending in parallel with the central axis and connected with the air block intake port.

26. The air block of claim 25, wherein the integrated seal is located in the air block upper chamber and the air block lower chamber.

27. The air block of claim 26, wherein the hollow cylindrical rear sealing member is located in a rear portion of the air block lower chamber and a rear portion of the air block upper chamber.

28. The air block of claim 26, wherein the ring-shaped front sealing member is located in a middle portion of the air block lower chamber and a middle portion of the air block upper chamber.

29-32. (Canceled)

33. A transmission line conveying apparatus comprising:
a transmission line drive assembly configured to apply a first component of a motive force to a transmission line by an engagement between the transmission line drive assembly and the transmission line; and
an air block configured to apply a second component of the motive force to the transmission line generated by pressurized air, comprising:
an air block housing; and
an integrated seal located in the air block housing, the integrated seal comprising:
a ring-shaped front sealing member;
a hollow cylindrical rear sealing member, the hollow cylindrical rear sealing member and the ring-shaped front sealing member sharing a central axis; and
a connecting sealing member connecting the ring-shaped front sealing member and the hollow cylindrical rear sealing member.

34. The transmission line conveying apparatus of claim 33, further comprising:
a mount frame, wherein the air block is fixed to the mount frame, and the transmission line drive assembly is slidably mounted to the mount frame;
a load cell having a first connector secured to the air block and a second connector secured to the transmission line drive assembly, the load cell being configured to measure the first component of the motive force; and
a local controller, the local controller being connected to an output port of the load cell to receive the measured first component of the motive force, the local controller being connected to the transmission line drive assembly to adjust operation parameters of the transmission line drive assembly to adjust the first component of the motive force, based on the measured first component of the motive force.

35-42. (canceled)
